(19) United States
(12) Patent Application Publication
(10) Pub. No.: US 2024/0037497 A1
(43) Pub. Date: Feb. 1, 2024

(54) SYSTEMS AND METHODS FOR REMEDIATING CHANGES IN ITEM LISTING DATA

(71) Applicant: Target Brands, Inc., Minneapolis, MN (US)

(72) Inventors: Dakota R. Brown, Minneapolis, MN (US); Craig Lenzen, Minneapolis, MN (US)

(21) Appl. No.: 18/226,530

(22) Filed: Jul. 26, 2023

Related U.S. Application Data
(60) Provisional application No. 63/393,121, filed on Jul. 28, 2022.

(51) Int. Cl. G06Q 10/087; G06Q 30/012; G06F 40/166; G06F 40/279; G06V 30/19

(52) U.S. Cl. CPC G06Q 10/087; G06Q 30/012; G06F 40/166; G06F 40/279; G06V 30/19

(57) ABSTRACT

The disclosed technology provides for implementing remediations to item listing data in an online retail environment. A method can include receiving, by a computing system from a data management system, a topic for a change in item listing data, retrieving, from a data store, at least one model trained to (i) identify changes in other item listing data, (ii) determine at least one suggested remediation to the changes to generate accurate item listing data, and (iii) determine at least one confidence metric indicating a likelihood that the at least one suggested remediation will result in generating the accurate item listing data, inputting the item listing data to the at least one model, receiving output from indicating at least one suggestion to remediate the item listing data, determining that the at least one suggestion satisfies auto-remediation criteria, and auto-remediating the item listing data with the at least one suggestion.

### CROSS-REFERENCE TO RELATED APPLICATIONS

This application claims the benefit of U.S. Application Ser. No. 63/393,121, filed on Jul. 28, 2022. The disclosure of the prior application is considered part of the disclosure of this application, and is incorporated in its entirety into this application.

### TECHNICAL FIELD

This document describes devices, systems, and methods related to identifying and remediating changes in item listing data in online retail environments to improve system efficiency and optimize consumer-centric data.

### BACKGROUND

Online retail environments, such as retail websites, can sell items (e.g., products) to end consumers. End consumers can search for items on the online retail environments and decide whether to purchase items and which items to purchase based on information presented about the items thereon. Each item can have a listing on the online retail environment. The listing can include information about the item, such as a title, price, and description. Sometimes, item listings may be missing information, outdated, incomplete, or duplicative. When item listings are incomplete and/or inaccurate, end consumers may be less inclined to purchase those items and may experience a lower shopping experience. Sometimes, the end consumers may have less confidence in the items that are being sold and therefore may not purchase items from that online retail environment.

### SUMMARY

The document generally relates to identifying and remediating changes in item listings on online retail environments to provide accurate and useful information to end consumers. More specifically, the disclosed technology provides for automatically detecting changes to item listing data, running the changed data through various different models for identifying potential remediations, and providing options for auto-remediation, user-initiated remediation, and user override of system decisions to fix the changed data and ensure its accuracy, completeness, validity, timeliness, and/or consistency.

A computer system, for example, can monitor for and detect changes to item listing data that is served to guests in an online retail environment. When the item listing data is changed, the computer system can run the changed data against one or more machine learning models. Each model can be trained to identify a different attribute in the changed data, generate a score indicating likelihood that the change should be remediated, and generate one or more suggestions for remediating the change. The models can include, but are not limited to, an electronic service plan model, a package dimension outlier detection model, an item type classifier model, a license personality and property model, a profanity model, a dimensional drawings model, and an image labeling model. One or more other models can also be generated, trained, and used with the disclosed technology. For example, one or more models can be trained to identify changes to be made to item listing data for particular item types and/or item categories. An item category of sandals, as an illustrative example, can have multiple models configured to detect and identify potential issues with regards to various attributes associated with the sandals category, groups of attributes associated with the sandals category, and/or attributes associated with subtypes of the sandals category (e.g., ballet flats, clogs, open-toe sandals, etc.). The computer system can automatically remediate some changes to item listing data without presenting the auto-remediations to a user (for example, if the score indicating likelihood that the change should be remediated exceeds a predetermined threshold value). Other times, the computer system can present the user with an option to select option(s) for remediating the change (for example, if the score indicating the likelihood that the change should be remediated is less than the same or a different threshold value).

Sometimes, the user can also override a decision to remediate a change to item listing data that is automatically made by the computer system (e.g., an auto-remediation) or suggested by the computer system (which can be presented to the user and selected by the user). When the user overrides the decision, the computer system can implement that override across all its future decisions. The computer system can also use this override to continuously improve and train one or more of the models described herein. As an illustrative example, the computer system may determine that any title having “peanuts” relates to a cartoon character, but the user can override this decision and identify “peanuts” with food items. The computer system can implement this override in all future decisions so that if “peanuts” appears in a title again, the computer system can identify it as relating to food items rather than the cartoon character items.

One or more embodiments described herein can include a method for implementing remediations to item listing data in an online retail environment, the method including: receiving, by a computing system from a data management system, a topic for a change in item listing data, retrieving, by the computing system from a data store, at least one model having been trained using machine learning techniques to (i) identify changes in other item listing data, (ii) determine at least one suggested remediation to the changes in the other item listing data to generate accurate item listing data, and (iii) determine at least one confidence metric indicating a likelihood that the at least one suggested remediation will result in generating the accurate item listing data, inputting, by the computing system, the item listing data associated with the topic as input to the at least one model, receiving, by the computing system, output from the at least one model indicating at least one suggestion to remediate the item listing data, determining, by the computing system, that the at least one suggestion satisfies auto-remediation criteria, and auto-remediating, by the computing system and based on a determination that the at least one suggestion satisfies the auto-remediation criteria, the item listing data with the at least one suggestion.

In some implementations, the embodiments described herein can optionally include one or more of the following features. For example, the at least one model can be at least one of an electronic service plan model, a package dimensions model, an item type model, an item subtype model, a license personality and property model, a profanity model, a dimensional drawings model, and an image labeling model. In some implementations, determining, by the computing system, that the at least one suggestion satisfies auto-remediation criteria can include determining that a confidence metric generated by the at least one model and received as output from the at least one model exceeds a threshold confidence range, the confidence metric indicating the likelihood that the at least one suggestion results in generating accurate item listing data.

As another example, the method can include receiving, by the computing system from the data management system, a topic for a change in second item listing data, inputting, by the computing system, the second item listing data as input to the at least one model, receiving, by the computing system, output from the at least one model indicating a second suggested remediation for the second item listing data, determining, by the computing system, that the second suggested remediation does not satisfy the auto-remediation criteria, flagging, by the computing system and based on the determination that the second suggested remediation does not satisfy the auto-remediation criteria, the second item listing data as flagged item listing data, generating, by the computing system, output to be presented in a graphical user interface (GUI) display at a user device indicating the second suggested remediation for the flagged item listing data, and transmitting, by the computing system to the user device, the generated output. In some implementations, the method can also include receiving, by the computing system from the user device, user input indicating (i) a rejection of the second suggested remediation and (ii) identification of a user-defined remediation for the flagged item listing data, implementing, by the computing system, the user-defined remediation to update the flagged item listing data, and training, by the computing system, the at least one model to identify the user-defined remediation as a remediation for the other item listing data that does not satisfy the auto-remediation criteria. The method can also include training, by the computing system, the at least one model to identify the user-defined remediation for the other item listing data instead of the second suggested remediation. The model can be trained, in some implementations, to identify the user-defined remediation for a subset of the other item listing data, the subset of the other item listing data having at least one of (i) a same item type as the flagged item listing data and (ii) a same item category as the flagged item listing data.

In some implementations, the at least one model could have been trained to identify, in the other item listing data, changes in at least one of item: accuracy, completeness, timeliness, uniqueness, validity, and consistency. A change in the item accuracy can include at least one of an inaccurate item type and inaccurate package dimensions, a change in the item completeness can include a missing merchant type attribute that is required for the other item listing data, a change in the item timeliness can include a threshold amount of time that passed since the other item listing data was updated, a change in the item uniqueness can include an item identifier or an item title that is identical to another item identifier or another item title, a change in the item validity can include at least one of an invalid brand and an invalid item taxonomy, and a change in the item consistency can include an inconsistency of at least one of brand and item taxonomy for the other item listing data across data systems associated with the online retail environment.

As another example, the at least one model can be an electronic service plan model that was trained to: determine, based at least in part on the item listing data, whether a warranty applies to an item in the item listing data, determine, based on a determination that the warranty applies, whether the item listing data includes an indication of the warranty, and generate, based on a determination that the item listing data does not include the indication of the warranty, a confidence metric above a threshold value, the confidence metric above the threshold value indicating that the item listing data can be auto-remediated to include the indication of the warranty. The method can also include auto-remediating, by the computing system and based on the confidence metric being above the threshold value, the item listing data to include an indication of the warranty.

As another example, the at least one model can be a package dimensions model that was trained to: determine, based at least in part on the item listing data, whether package dimensions in the item listing data satisfy threshold package dimensions criteria for items of at least one of (i) a same item category and (ii) a same item type, and generate, based on a determination that the item listing data does not satisfy the threshold package dimensions criteria, a confidence metric below a threshold value, the confidence metric below the threshold value indicating that the item listing data should be flagged, by the computing system, for review by a user of the user device.

As another example, the at least one model can be an item type model that was trained to: predict, based at least in part on the item listing data, at least one item category for which to categorize an item associated with the item listing data, determine, for the at least one predicted item category and based at least in part on the item listing data, a confidence metric indicating a likelihood that the at least one predicted item category is a correct item category for the item, generate, based on the confidence metric exceeding a threshold range, instructions that, when executed by the computing system, cause the computing system to auto-remediate the item listing data by adding an indication of the at least one predicted item category to the item listing data, and generate, based on the confidence metric being less than the threshold range, output to be presented at the GUI display of the user device, the output indicating the at least one suggestion to remediate the item listing data, the at least one suggestion including an option to update the item listing data to include an indication of the at least one predicted item category.

As another example, the at least one model can be a license personality and property model that was trained to: identify, based at least in part on the item listing data, at least one license for which to associate an item in the item listing data, the at least one license including copyrighted or trademarked information, determine, for the at least one identified license, a confidence metric indicating a likelihood that the at least one identified license is correctly associated with the item in the item listing data, generate, based on the confidence metric exceeding a threshold range, instructions that, when executed by the computing system, cause the computing system to auto-remediate the item listing data by adding an indication of the at least one license to the item listing data, and generate, based on the confidence metric being less than the threshold range, output to be presented at the GUI display of the user device, the output indicating the at least one suggestion to remediate the item listing data, the at least one suggestion including an option to update the item listing data to include an indication of the at least one identified license.

In some implementations, the at least one model can be a profanity model that was trained to: identify at least one word in the item listing data that satisfies profanity criteria, determine, for the at least one word, a confidence metric indicating a likelihood that the at least one word is profane, generate, based on the confidence metric exceeding a threshold range, instructions that, when executed by the computing system, cause the computing system to auto-remediate the item listing data by removing the at least one word in the item listing data, and generate, based on the confidence metric being less than the threshold range, output to be presented at the GUI display of the user device, the output indicating the at least one suggestion to remediate the item listing data, the at least one suggestion including an option to update the item listing data to remove the at least one word from the item listing data.

As another example, the at least one model can be a dimensional drawings model that was trained to: determine, based at least in part on the item listing data, whether an image in the item listing data includes item dimensions, determine, based on a determination that the image includes item dimensions, whether the item dimensions are accurate for items of a same type as the item listing data, determine, based on a determination that the image includes inaccurate item dimensions, a confidence metric indicating a likelihood that the image includes inaccurate item dimensions, and generate, based on the confidence metric exceeding a threshold range, output to be presented at the GUI display of the user device, the output indicating the at least one suggestion to remediate the item listing data, the at least one suggestion including an option to update the item listing data to include accurate item dimensions in the image. In some implementations, the dimensional drawings model can also be trained to: determine, based at least in part on the item listing data, whether text in the image complies with accessibility standards, generate, based on a determination that the text in the image does not comply with the accessibility standards, another confidence metric, and generate, based on the another confidence metric exceeding a threshold range, another output to be presented at the GUI display of the user device, the another output indicating the at least one suggestion to remediate the item listing data, the at least one suggestion including an option to update the text in the image of the item listing data to comply with the accessibility standards.

In some implementations, the at least one model can be an image labeling model that was trained to: determine, based at least in part on the item listing data, whether a set of images in the item listing data include threshold viewpoints of an item of the item listing data, determine, based on a determination that the set of images does not include the threshold viewpoints, a confidence metric indicating a likelihood that the set of images is incomplete, and generate, based on the confidence metric exceeding a threshold range, output to be presented at the GUI display of the user device, the output indicating the at least one suggestion to remediate the item listing data, the at least one suggestion including an option to update the item listing data to include additional images in the set of images that satisfy the threshold viewpoints. The threshold viewpoints can include at least one of a front view of the item, a right side view of the item, a left side view of the item, a top view of the item, a bottom view of the item, and a back view of the item.

In some implementations, the at least one model can include a first model and a second model, the first model being a package dimensions model and the second model being an item type model. The at least one model further can also include a third model, the third model being an electronic service plan model. The at least one model further can include a fourth model, the fourth model being an item subtype model. The at least one model further can include a fifth model, the fifth model being a license personality and property model. The at least one model further can include a sixth model, the sixth model being a profanity model. The at least one model further can include a seventh model, the seventh model being a dimensional drawings model. The at least one model further can include an eighth model, the eighth model being an image labeling model.

One or more embodiments described herein can include a computing system for determining remediations to item listing data in an online retail environment, the computing system including: one or more processors, and one or more computer-readable devices including instructions that, when executed by the one or more processors, cause the computing system to perform operations that can include: receiving, from a data management system, a topic for a change in item listing data, retrieving, from a data store, at least one model that was trained using machine learning techniques to (i) identify changes in other item listing data, (ii) determine at least one suggested remediation to the changes in the other item listing data to generate accurate item listing data, and (iii) determine at least one confidence metric indicating a likelihood that the at least one suggested remediation will result in generating the accurate item listing data, inputting the item listing data associated with the topic as input to the at least one model, receiving output from the at least one model indicating at least one suggestion to remediate the item listing data, determining that the at least one suggestion satisfies auto-remediation criteria, and auto-remediating, based on a determination that the at least one suggestion satisfies the auto-remediation criteria, the item listing data with the at least one suggestion.

In some implementations, the computing system can optionally include one or more of the abovementioned features.

The devices, system, and techniques described herein may provide one or more of the following advantages. For example, the disclosed technology provides for distilling an abundance of complex information in quality, performance, and decision intelligence into digestible content that is simple to publish, consume, and verify. Automated processes to distill this information can provide more accurate insights about accuracy in item listing data and remediation of inaccuracies in such item listing data. Automation can also improve ability to check an abundance of information and correct that information with minimal human intervention and/or feedback. This can improve not only efficiency of a data remediation process but also improve the humans' time efficiency and ability to perform other tasks.

The disclosed technology can also provide for monitoring incremental changes to item listing data before running models to check whether to remediate the changes to that data, which can improve efficiency and use of available compute resources and processing power. Moreover, many models can be run to check the incremental changes to item listing data, and each model can be trained to identify and analyze different attributes of the item listing data to provide accurate, curated, and streamlined remediation operations to improve the item listing data.

For example, the disclosed techniques can improve end consumer confidence in item listings, an online retail environment, purchase decisions, and shopping experiences. This can be achieved by automatically and quickly identifying and remediating issues or changes in item listing data across different systems, which otherwise may be time-consuming or impossible by a human, such as a retail store employee. The disclosed techniques can also prioritize remediating item listing data that is critical to consumer confidence and decisions to purchase from the online retail environment by auto-remediating certain changes in the item listing data without intervention from a human, such as a retail store employee. Thus, the right data quality problems can be quickly identified and addressed using such automated techniques, thereby improving consumer experiences and improving online retail sales.

Moreover, the disclosed techniques can be beneficial to increase convenience of navigating the online retail environment and finding desirable items. Consumers can more easily find items they wish to purchase when they can search for different features or information about items that are accurately recorded across datasets and different computing systems. Since the disclosed techniques provide for improving item listing data by ensuring the item listing data is complete, accurate, consistent, timely, unique, and valid, consumers can search and more easily find the items they wish to purchase. This can further improve consumer confidence, their purchasing decisions, and their overall shopping experiences. This improved searchability can also decrease the amount of time that each consumer engages with the system during a particular session, thereby reducing processing and communication bandwidth requirements for the system, which frees up these resources for other purposes.

As another example, the disclosed techniques can provide an automated approach for culling different types of data from a variety of sources to identify whether item listings have changed, present accurate information to end consumers, and/or has not changed or been updated over some period of time. The disclosed techniques can integrate data from multiple different systems (e.g., computers, devices, networks, databases, etc.) with automated flagging and automated remediating of issues, errors, or changes in item listing data. Furthermore, using the disclosed techniques, information can be corrected in an automated way, which can provide for deleting or otherwise removing duplicative or unnecessary information stored in the multiple different systems. This can improve use of computational resources, processing power, and efficiency of the different systems.

Moreover, it can be a time-consuming and tedious process for retail employees to manually perform an audit process of each item listing in the retail environment. Sometimes, the retail employees may make errors or overlook data in an item listing that should be corrected. Thus, a retail employee's assessment of quality may not be accurate or up to date. The disclosed techniques, on the other hand, provide an automated and quick approach for auditing the item listing data and auto-remediating issues or changes in the item listing data, which otherwise may not be feasible by a human reviewer. The disclosed techniques can remove potential human error and reduce an amount of time needed to audit and remediate item listing data across the different systems.

As another example, the disclosed techniques provide for increased speed at which data quality issues are automatically remediated. Data quality issues can be resolved automatically, quickly, and accurately, thereby improving overall quality offered by the retail environment and improved consumer experiences. Automatic remediation can be beneficial to reduce an amount of time needed by relevant users (e.g., retail employees) to comb through item listing data, determine what can be improved, and make the improvements themselves. Automatic remediation can allow for the relevant users to focus their attention on other tasks. Automatic remediation can also allow for reducing or otherwise avoiding human error that may occur if the relevant users spend their time manually fixing data quality issues. Moreover, automatic remediation can result in increased scalability and extensibility of the disclosed techniques, thereby providing for vast and real-time improvement of item listings and overall data quality for the retail environment.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram for determining modifications that can be made to item listing data in an online retail environment.

FIG. 1B is a conceptual diagram of a process for remediating item listing data in the online retail environment.

FIG. 1C is a conceptual diagram for determining whether to auto-remediate or flag item listing data in the online retail environment.

FIG. 1D shows an example item listing in an online retail environment.

FIG. 2 is a system diagram depicting one or more components that can be used to perform the techniques described herein.

FIGS. 3A-C is a flowchart of a process for remediating item listing data in the online retail environment.

FIG. 4 is a flowchart of a process for manually remediating item listing data in the online retail environment.

FIG. 5A is a flowchart of a process for overriding a remediation that was made to item listing data in the online retail environment.

FIG. 5B is a flowchart of another process for overriding a remediation inference for item listing data in the online retail environment.

FIG. 6 illustrates an example user interface presenting models that can be used to determine whether to remediate item listing data.

FIG. 7 illustrates an example user interface presenting potential remediations that can be made based on applying an item type model to item listing data.

FIG. 8 illustrates an example user interface presenting potential remediations that can be made based on applying a license personality and property model to item listing data.

FIG. 9 illustrates an example user interface presenting potential remediations that can be made based on applying a package dimensions model to item listing data.

FIG. 10 illustrates an example user interface for flagging issues in item listing data that can be auto-remediated or manually remediated.

FIG. 11 illustrates an example user interface for auto-remediating item listing data.

FIG. 12 illustrates an example user interface for presenting flagged item listing data to a user, such as a retail environment employee.

FIG. 13 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to identifying and remediating changes in item listings on online retail environments to provide accurate and useful information to end consumers. The disclosed technology can provide for delivering enterprise value through accelerated automation, elevated analytical insights, and guest-centric data optimization. Guest-centric data, for example, can be optimized using the disclosed technology to improve quality and value of item listings. The disclosed technology provides a toolset for automating reporting, insights, and remediation of item listings to improve item performance in the online retail environment. Moreover, consumers can have improved shopping experiences and can make informed purchase decisions based on item information that is continuously maintained and/or improved using the disclosed technology.

For example, a computer system can monitor item listing data to determine when that item listing data has changed. The computer system can apply one or more machine learning trained models to the changed item listing data to determine whether the changes are accurate and/or whether remediations should be made to the item listing data. The computer system can therefore make decisions regarding recommended actions to be taken against the item listing data (or other types of item records and data) in order to improve the item listing data's quality and/or performance. The computer system can flag the item listing data when a user, such as an employee of the online retail environment, should review the changed item listing data and determine whether to implement a remediation generated by the computer system. Therefore, flagging decisions can be published to user devices or other user review systems for the user to review and act upon. The computer system can also perform automatic remediations of the item listing data in some implementations. In some implementations, automatic remediations can be a default decision. Then, if the automatic remediation cannot be performed (e.g., a probability that item listing data is erroneous is below a threshold level), the flagging decision can be published as described above.

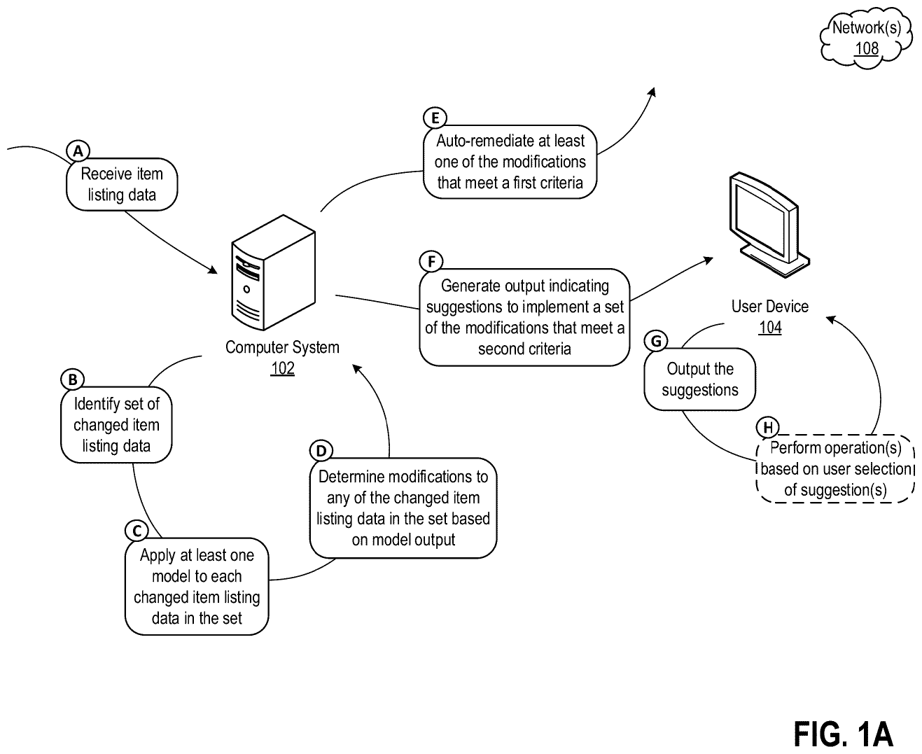

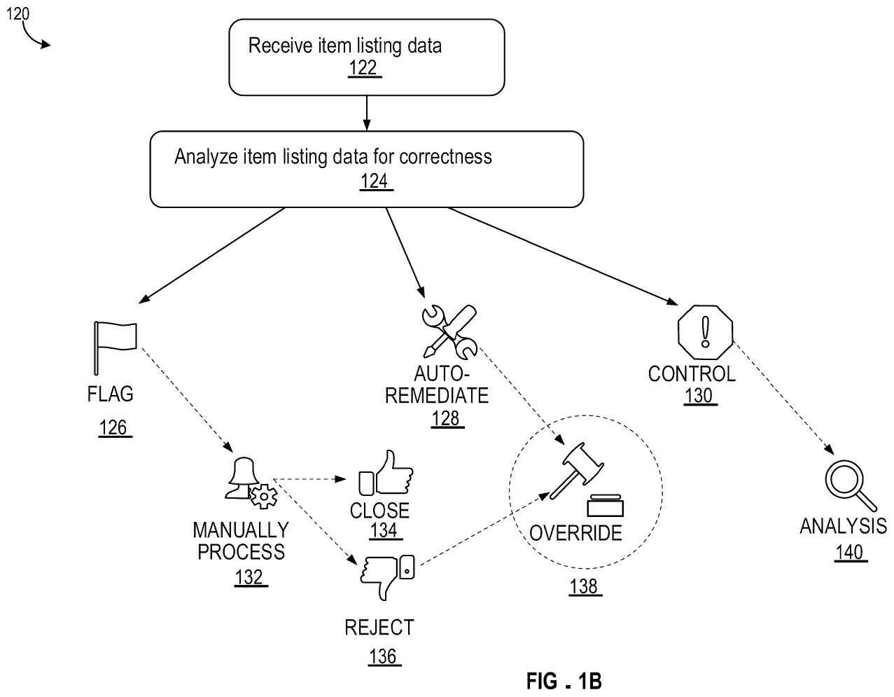

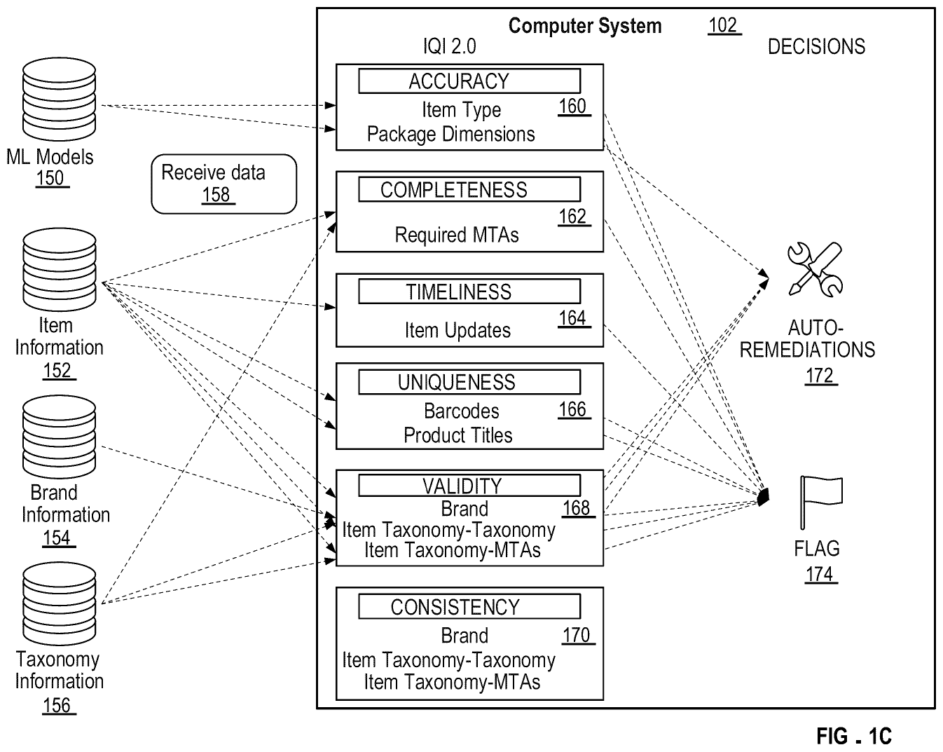

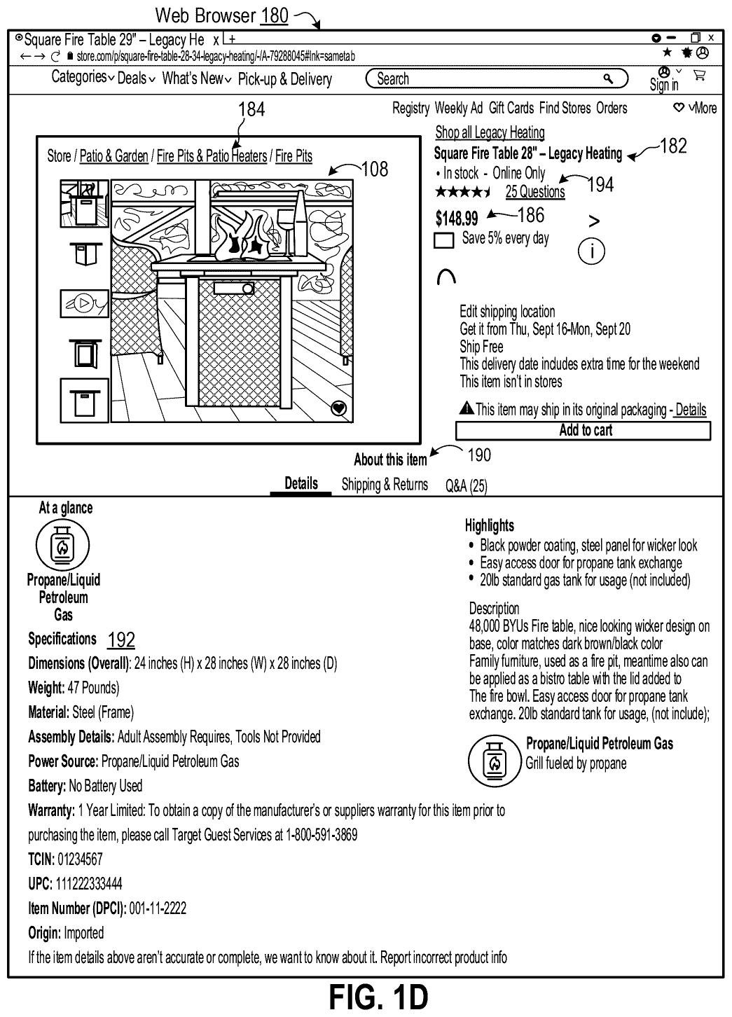

FIG. 1A is a conceptual diagram for determining modifications that can be made to item listing data in an online retail environment. The online retail environment can be a website or other platform for selling items (e.g., products) to a wide audience (e.g., location, national, and/or international audience). The online retail environment can be part of a physical retail environment, such as a store. The online retail environment can also be associated with one or more warehouses and/or storage facilities. In some implementations, the online retail environment can sell the same, similar, and/or different produces as the physical retail environment. In some implementations, the online retail environment may not be associated with any particular physical retail environment or network of stores. The online retail environment can provide consumers with products that can be purchased from a variety of different sellers, including individual sellers, small shops, and/or enterprises/companies.

The item listing data can be a record of data associated with an item available for purchase at the online retail environment. In some implementations, the item listing data can include more information than an amount of information that is published and shared with consumers on the online retail environment. In some implementations, the item listing data described herein can be a record of item data that has been published to the online retail environment. In some implementations, the item listing data can be a record of item data that has not yet been published to the online retail environment. In such a scenario, the item listing data can be checked for potential remediations before it is published to ensure positive consumer experiences as soon as the item listing data becomes available to them. Refer to FIG. 1D for additional discussion about what the item listing data may include.

As shown in the example in FIG. 1A, a computer system 102 and a user device 104 can be in communication (e.g., wired and/or wireless) via network 108. The computer system 102 can be a cloud-based service and/or system, computing device, and/or network of computing devices, systems, or servers. The user device 104 can be a client computing device, including but not limited to a computer, laptop, tablet, mobile phone, smartphone, and/or cellphone. The user device 104 can be used by a relevant user, such as a retail employee and/or a quality control analyst. The user device 104 can include one or more applications, programs, software, and/or services that allow a relevant user to review item listing data and perform operations to improve and/or modify that data (e.g., when auto-remediations are not performed by the computer system 102 or another computing system). The relevant user can be, in some implementations, an employee of the retail environment and/or a quality control analyst. Although depicted as separate, in some implementations, the computer system 102 and the user device 104 can be a same computing system.

The computer system 102 can receive item listing data in block A. The item listing data can include a record of data associated with an item sold at the online retail environment, as shown and described in FIG. 1D. Sometimes, the item listing data can include more information about the item than information presented at the online retail environment for the particular item. In some implementations, the item listing data may only include information about the item that is made publically available to end consumers at the online retail environment.

The item listing data can be received/retrieved from a variety of sources. In some implementations, the computer system 102 can pull/retrieve the item listing data directly from an online retail environment, such as from a website for the online retail environment. In some implementations, the item listing data can be retrieved from a data store before the item listing data is published to the website for the online retail environment. The item listing data can also be received from an item supplier, an automated item review tool, one or more retail environment employees, a retail environment data store, and/or one or more web servers.

For example, the item supplier can include a cloud-based system or server, a computing system, and/or a data store that maintains information (e.g., title, description, images, dimensions, weight, other specifications, etc.) about items of the supplier. The item supplier can update this information periodically and/or based on policies of the supplier. Whenever the item supplier updates the information for a particular item, the item supplier can transmit the updated information to the computer system 102. The computer system 102 can also poll the item supplier at predetermined time intervals and/or periodically to see whether the item supplier has updated any of the item information. If information has been updated, the item supplier can respond to the poll by transmitting the information to the computer system 102. In some implementations, the item supplier can transmit item listing data to the computer system 102 at predetermined time intervals (e.g., once a day, twice a day, whenever a new item is provided by the item supplier, etc.).

The automated item review tool can be implemented at the computer system 102 and/or some client side device, such as a computing device of a consumer, retail employee, or quality control analyst. The tool can be configured to scan item listing data as it is presented in a web browser at the computer system 102 and/or a client side device, such as a user device of an end consumer. The scanned item listing data can be transmitted to the computer system 102. The item listing data can be scanned periodically and/or at predetermined time intervals (e.g., once a day, twice a day, fifteen times a day, etc.). The tool can be configured to transmit all data that appears in the item listing. In some implementations, the tool can transmit only a portion of the data that appears in the item listing. For example, the tool can be configured to identify fields in a specification of an item that are missing information (e.g., empty fields, null fields, etc.). The tool can also be configured to identify information that has been updated or recently added within some threshold period of time. Only those identified fields can then be sent to the computer system 102 for further analysis, for example.

In some implementations, the automated item review tool can be or include a microservice or other application/program/software that can be run at the computer system 102, the user device 104, and/or another computing system. The tool can be configured to receive image data of an item and/or an item listing and process that image data to detect item listing data. For example, the tool can utilize optical character recognition (OCR) techniques to detect a title, description, barcode, and/or other unique identifier from the image data. Such detected data can then be transmitted to the computer system 102 for further analysis. Such detected data can also be transmitted to a data store for storage and future retrieval and analysis.

The retail environment employee(s) can manually review one or more items that are listed on the online retail environment. The employee(s) can, for example, manually review the items in a physical retail environment, such as checking their respective item identifiers (e.g., barcodes, SKUs, etc.), titles, descriptions, prices, weight, dimensions, and/or visual features. The employee(s) can input their observations into an application or other service presented at a user device of the employee(s), such as the user device 104. This input can be provided to the computer system 102 for further analysis. In some implementations, the employee(s) can review item listing data on the online retail environment. Thus, the employee(s) can review particular pieces of information in an item listing, such as customer reviews, title, description, taxonomy, image data, specification, etc. The employee(s) can input information about their review of the item listing into an application or other service presented at their device, which can be transmitted to the computer system 102 for further analysis. In some implementations, the computer system 102 can receive random spot checks for items that are available in the physical retail environment (e.g., from the retail environment employee(s), a mobile/robotic imaging machine in the physical retail environment, or any other systems, devices, and/or components described herein). These spot checks can be provided to the computer system 102 in block A for further analysis. In some implementations, the computer system 102 can initiate random spot checks by sending communications to one or more computing devices of employees. In some implementations, the computer system 102 can initiate spot checks for items that have not been physically examined in a set period of time.

The retail environment data store can be a database, data store, data repository, data lake, and/or cloud-based storage. The data store can be configured to maintain information about each item that is listed in the online retail environment. The computer system 102 can therefore retrieve item listing data from the data store.

In some cases, the web server can provide item listing data to the computer system 102 when that item listing is loaded in a web browser at a client side device. The web server can provide the entire item listing to the computer system 102. The web server can also provide portions of the item listing and/or some pieces of data from the item listing to the computer system 102. The webserver can provide the item listing data to the computer system 102 periodically (e.g., 15 times a day, once a day, every 5 hours, etc.), at predetermined time intervals, or whenever an item listing is requested and presented at a client side device.

Furthermore, the computer system 102 can receive the item listing data at one or more different times. For example, the computer system 102 can receive all item listing data for a particular online retail environment at predetermined times (e.g., once a day, three times a week, once a week, etc.). As another example, the computer system 102 can receive item listing data that has been assessed by the computer system 102 (or another computer system) and assigned a quality score below some threshold value. The quality score can indicate one or more dimensions of quality that can be used to determine whether the item listing data has inaccuracies and therefore should be updated, changed, or otherwise remediated (e.g., autonomously, semi-autonomously, manually). The dimensions can include accuracy, completeness, timeliness, uniqueness, validity, and/or consistency of the item listing data. As yet another example, the computer system 102 can receive item listing data that has been changed, updated, or modified within some threshold period of time (e.g., item listing data that has been changed since a last time it was scored/given a quality score, item listing data that has never been scored before, item listing data that has been changed within a past 3 hours, 5 hours, 12 hours, 24 hours, 35 hours, 48 hours, 72 hours, etc.).

The computer system 102 can identify a set of changed item listing data in block B. For example, the computer system 102 can compare the received item listing data to prior identified listing data for the same item. The computer system 102 can also compare timestamps indicating changes/edits/modifications that have been to the item listing data to identify the set of changed item listing data. In some implementations, identifying the set of changed data can include comparing the item listing data to expected values and/or data for a particular item to determine whether the item listing data deviates from those expectations by a threshold amount. In yet some implementations, identifying the set of changed data an include identifying item listing data having a quality score below a threshold value/range.

In some implementations, the computer system 102 may only receive changed item listing data in block A. Thus, the computer system 102 may not perform block B. In some implementations, the computer system 102 may not perform block B if the computer system 102 is configured to check all item listing data that is received in block A for potential remediations.

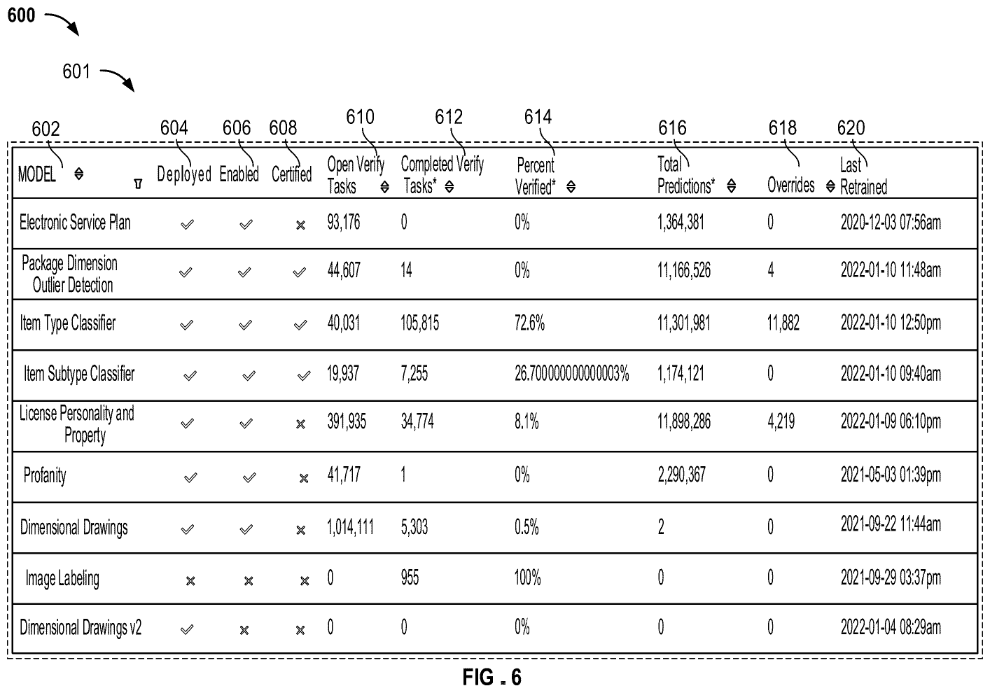

In Block C, the computer system 102 can apply at least one model to each changed item listing data in the set (or to newly received item listing data). Each of the models can be trained using machine learning techniques to identify different information in the item listing data or aspects of the information that may require remediation(s). Each of the models can be trained using different rulesets to generate different types of output. For example, some models can be trained to generate at least one suggestion for remediating the item listing data. As another example, some models can be trained to generate a score or other value indicating a likelihood that the item listing data contains inaccuracies that should be remediated (either autonomously or manually by the relevant user). As yet another example, some models can be trained to generate at least one suggestion and a likelihood for remediation score. Refer to FIGS. 6-9 for additional information about the models.

The computer system 102 can then determine modifications to any of the changed item listing data in the set based on the model output (block D). In some implementations, the modifications can be generated by the models and provided as output to the computer system 102. In some implementations, the model output can include scores indicating likelihood that the item listing data should be remediated and/or likelihood that a predicted value is a correct value for the item listing data. If the score(s) satisfies some threshold value, the computer system 102 can determine that it can automatically remediate the item listing data based on the model output. On the other hand, if the score(s) does not satisfy the threshold value, then the computer system 102 can flag the item listing data and present a suggested modification to the relevant user at the user device.

Accordingly, the computer system 102 can auto-remediate at least one of the modifications that meet a first criteria (block E). The first criteria can be a remediation score, as described above, satisfying some predetermined or calculated threshold value and/or range. The first criteria can also correspond to a type of the modifications that are determined in block D. For example, a modification directed towards spelling errors in a title, detailed description, or other part of the item listing data can be the first criteria (therefore, if the modification includes removing a misspelling in the title, this modification can be automatically performed by the computer system 102). On the other hand, a modification directed towards changing an entire taxonomy or classification of the item in the item listing data may not satisfy the first criteria and thus may require the relevant user to review. The first criteria can also correspond to a type of model that generates output used to determine the modifications in block D. In other words, certain models can be trained to generate output that can then be used for auto-remediations. Some models, on the other hand, may only indicate that a modification can be made without suggesting the modification. One or more other criteria can be used in block E.

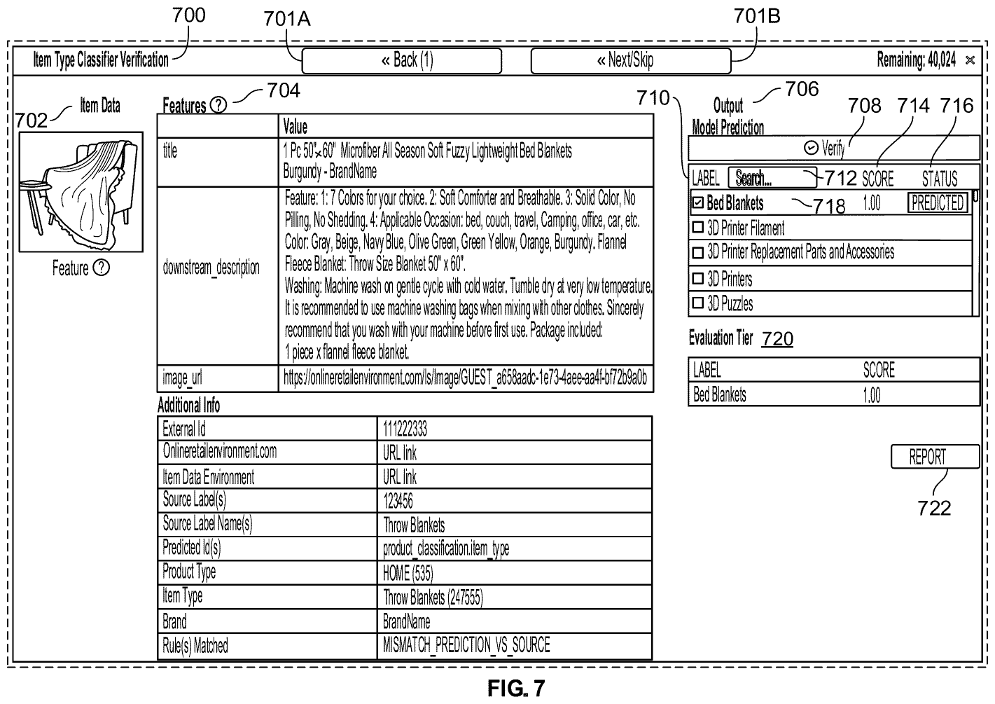

The computer system 102 can generate output indicating suggestions to implement a set of the modifications that meet a second criteria (block F). The output can then be transmitted to the user device 104. The suggestions can be outputted when the first criteria is not met in block E. In other words, if the computer system 102 cannot automatically remediate the item listing data using at least one of the modifications, then the item listing data should be checked by the relevant user. The relevant user can review the item listing data and the suggestions to determine whether the modifications are appropriate and/or should be implemented. The relevant user can also decide whether to override any of the suggested modifications. Refer to FIGS. 7-10 and 12 for additional discussion.

The user device 104 can output the suggestions (block G). The suggestions, as described herein, can include portions of the item listing data that are flagged. Flags can therefore be used to bring the relevant user's attention to particular portions of the item listing data that may be remediated (based on the output from the at least one model). The flags can include one or more suggested modifications from which the relevant user can select for implementation. In some implementations, for example, the user device 104 can be used by an item supplier. The item supplier can be prompted to provide information that can be used to update the item listing data.

Optionally, the user device 104 can perform one or more operations based on user selection of one or more suggestions (block H). In other words, the user device 104 can generate instructions that are transmitted back to the computer system 102 and used by the computer system 102 to implement the user-selected suggestions. The one or more operations can include overrides of system-generated and/or system-implemented remediations. The one or more operations can also include selecting or accepting a modification that is suggested by the computer system 102.

The steps A-H described in FIG. 1A can be automatically performed periodically, at predetermined time intervals, and/or by request of the user or another relevant user at the user device 104. For example, the steps A-H can be performed every 20 minutes, 30 minutes, 1 hour, 4 hours, once a day, etc. The steps A-H can be performed at different time intervals for different items and/or item categories. In some implementations the steps A-H are performed when a new item listing is added to the system (such as be being stored in a data store of the system). Steps A-H can also be performed whenever an item listing is updated in the system, as described herein. Moreover, steps A-H can be performed in near real-time and/or in real-time.

FIG. 1B is a conceptual diagram of a process 120 for remediating item listing data in the online retail environment. The process 120 can be performed by the computer system 102 described in reference to FIG. 1A. In some implementations, one or more blocks of the process 120 can also be performed by one or more other computing systems, devices, and/or network of computing systems and/or devices. For illustrative purposes, the process 120 is described from the perspective of a computer system.

Referring to the process 120, the computer system can receive item listing data in block 122. Refer to block A in FIG. 1A for additional discussion.

In block 124, the computer system can analyze the item listing data for correctness. In other words, the computer system can determine whether the item listing data has changed and whether one or more modifications can be made to remediate the changed item listing data. In some implementations, determining item listing data correctness can also include reviewing new item listing data to determine if the information is likely to be correct or incorrect for the given item. Refer to blocks B-D in FIG. 1A for additional discussion.

As described herein, based on the analysis in block 124, the computer system can perform various operations. For example, the computer system can flag the item listing data in block 126. The computer system can also auto-remediate the item listing data in block 128. In some implementations, the computer system can generate a control based on the item listing data in block 130.

Flags, for example, can be published when there is a high level of confidence that an existing value in the item listing data should be reviewed. For example, if a value, such as product dimension, is currently incomplete or might not be accurate (as determined by at least one model that is applied to the item listing data), but a more appropriate value cannot be automatically and autonomously suggested by the computer system, then the flag can be published in block 126. The flagged item listing data can be presented to a relevant user at their respective user device so that a manual review process can be performed (block 132). The manual review process can include closing the flag (block 134). Closing the flag can occur when a relevant user applies a remediation decision presented with the flagged item listing data. The manual review process can also include rejecting the flag (block 136). Rejecting the flag can occur when the relevant user determines that a remediation decision presented with the flagged item listing data is incorrect and then manually closes or cancels the remediation decision.

In some implementations, the relevant user can reject the flag, which means that the relevant user does not agree with a suggested remediation for the item listing data. The relevant user can then perform an override process (block 138) in order to ensure that the suggested remediation is not performed by the computer system for the particular item listing data and other item listing data that may share one or more characteristics with the particular item listing data. For example, a model can generate output indicating that a pair of boots in an item listing data are called Rocky but that they are associated with the Rocky movies, rather than the shoe brand. The model can publish a decision that the boots have a license personality of the Rocky movies. During the override process in block 138, the relevant user can select an option to remove the Rocky movies from being applied to and associated with the boots as the license personality. Once the relevant user saves this override, the computer system can automatically override all similar decisions that were made to ensure that the Rocky movies do not apply as the license personality for other items of a same brand, similar category, and/or item type.

Auto-remediations (block 128) can be published to the computer system when there is a high level of confidence that an impactful alteration to the item listing data be autonomously made (e.g., value X should be Y). Thus, the computer system can automatically remediate the item listing data based on output from at least one model that is applied to the item listing data. As shown in the process 120, in some implementations, the auto-remediation can be overridden by the override process 138.

Controls (block 130) can be published based on sampling logic in order to establish control and experimental groups for later analysis (block 140). A control or experimental group can be defined as a category of items. The category can therefore be populated with items meeting criteria, conditions, and/or attributes associated with or otherwise defined for that category. The criteria, conditions, and/or attributes can include particular sales information and/or types of items.

FIG. 1C is a conceptual diagram for determining whether to auto-remediate or flag item listing data in the online retail environment. Data can be received by the computer system 102 to perform the techniques described herein (block 158). The data can be received from a variety of sources. For example, the data can be received from one or more data stores.

One or more models can be received from a models data store 150. Item information for a particular item listing data can be received from an item information data store 152. The data store 152 can contain certified datasets. In some implementations, the data store 152 can be a flat database. Brand information for the particular item listing data can be received from a brand information data store 154. Taxonomy information for the particular item listing data can be received from a taxonomy data store 156. The data stores 150, 152, 154, and 156 can be different and/or same data stores or other storage systems (e.g., cloud storage, databases, etc.). Any one or more of the data stores 150, 152, 154, and 156 can also be combined and/or a single data store.

Using the received data, the computer system 102 can assess the item listing data for correctness and determine whether one or more remediations should be made to the item listing data. For example, the computer system 102 can assess the item listing data for accuracy in block 160. This can include determining whether item type and/or package dimensions are accurate or should be modified to more accurate values. The computer system 102 can also assess completeness in block 162 to determine whether the item listing data contains appropriate and/or required merchant type attributes (MTAs). The computer system 102 can assess timeliness in block 164 to determine whether the item listing data has been updated within a timely manner (e.g., within a past week). The computer system 102 can also assess uniqueness in block 166 to determine whether the item listing data contains a unique barcode and/or product title, or whether the barcode and/or product title is duplicated across the online retail environment. Moreover, the computer system 102 can assess validity of the item listing data in block 168, which can include checking whether the item listing data contains a correct brand, item taxonomy, and/or MTAs. The computer system 102 can also assess validity in block 170 to determine whether consistent brand information, item taxonomy, and/or MTAs are identified and associated with the item listing data across different systems, engines, and/or modules of the computer system 102 and/or online retail environment.

Based on the computer system 102's analysis of the item listing data in blocks 160-170, the computer system 102 can perform auto-remediations in block 172 or flag the item listing data in block 174 for manual review/remediation, as described throughout this disclosure.

As an illustrative example, the computer system 102 can receive one or more machine learning models from the models data store 150 (block 158) and apply the models to item listing data for a bag of flour to determine whether the item listing data is accurate (block 160). The computer system 102 can determine that the package dimensions may be inaccurate but the computer system 102 is not certain what the package dimensions should be. Thus, the computer system 102 can flag the package dimensions for this item listing data (block 174). The computer system 102 can also determine that the item type is inaccurate and should be listed as grocery item instead of bedding and pillows. The computer system 102 can have high confidence in the item type inaccuracy (e.g., confidence above a threshold level) and can perform an auto-remediation to change the item type to grocery item (block 172).

As another example, the computer system 102 can receive item information from the data store 152 for the bag of flour item listing (block 158) and check the item listing for completeness in block 162. The computer system 102 can determine that the item listing is missing one or more required MTAs, and therefore can flag the MTAs in block 174. As another example, using the same data received from the data store 152, the computer system can check the item listing for timeliness (block 164), uniqueness (block 166), validity (block 168), and consistency (block 170). For timeliness and uniqueness, the computer system 102 may not be able to perform auto-remediations and thus may flag a last time the item listing data was updated, a barcode, and/or a product title for review by the relevant user (block 174). For validity and/or consistency, the computer system 102 may be able to perform one or more auto-remediations (block 172) but may also flag one or more of brand, item taxonomy, and/or MTAs for review by the relevant user (block 174).

Similarly, the computer system 102 can receive brand information from the data store 154 and use that information, alone or in combination with other data received in block 158, to determine validity of the item listing data (block 168) and/or consistency (block 170). The computer system 102 can also receive taxonomy information from the data store 156 and use that information, alone or in combination with other data received in block 158, to determine validity of the item listing data (block 168) and/or consistency (block 170) to then determine one or more auto-remediations (block 172) and/or flags (block 174). One or more other combinations of data can be received and used by the computer system 102 to assess correctness of item listing data and corresponding remediations.

FIG. 1D shows an example item listing in an online retail environment. The online retail environment can be a website 180 that is loaded in a web browser at a computing device, such as a user device (e.g., client device, client computing device). The website 180 can display selectable options for a user, such as a consumer, to navigate the online retail environment, search for items to purchase, log into and access user account information, review items to purchase, and purchase items. In some implementations, the item listing shown in FIG. 1D can be published and provided at the website 180 after it has been checked by the computer system 102 for potential remediations. The item listing can be generated from a record of data associated with an item that contains a variety of information about the item. In some implementations, some, rather than all, of the information contained in the record of data can be used to generate the item listing.

The example of FIG. 1D depicts an item listing for a fire table. The item listing includes a title 182. In this example, the title 182 is “Square Fire Table 28”—Legacy Heating.” The item listing includes a taxonomy 184 associated with the fire table. The taxonomy 184 indicates that the fire table is part of Patio & Garden>Fire Pits & Patio Heaters>Fire Pits. The item listing further includes a price 186. Here, the price 186 is $148.99. Image data 188 is also presented at the website 180. The image data 188 includes one or more images and/or videos depicting the fire table from various angles, how to use the fire table, and/or how to set up the fire table.

The item listing includes additional information about the fire table, which can be included in an About this item section 190. The section 190 can include tabs for information such as details, shipping and returns, reviews, questions and answers, etc. that may assist users in making purchase decisions. Users can navigate the section 190 by selecting the tabs described herein. One or more additional or fewer tabs can also be presented in the section 190, which can depend on the particular item, policy/guidelines of a supplier of the item, and/or policy/guidelines of the particular online retail environment.

The example section 190 in FIG. 1D includes “At a glance” information, which can provide a high level overview of what the item is and/or relates to, “Highlights” information about the item, specifications 192, and a description of the item. One or more other information can be presented in the section 190. The item listing can include additional information, such as customer reviews 194, which can assist users in making purchase decisions. The customer reviews 194, as described herein, can also be used to automatically assess quality of the item listing data based on one or more of the IQI scoring metrics (e.g., dimensions).

Any one or more of the title 182, the taxonomy 184, the price 186, the image data 188, the About this item section 190, the specifications 192, and the customer reviews 194 can be assessed using the disclosed techniques to determine whether the information is accurate and/or should be remediated. For example, the disclosed techniques can be used to determine whether the title 182 is unique and/or accurately describes the fire table, whether the taxonomy 184 is accurate, consistent, and/or valid, whether the price 186 is accurate, whether the image data 188 is accurate, complete, and/or timely, and/or whether the About this item section 190 and the specifications 192 (e.g., dimensions/measurements, color, weight, barcode or other identifier, etc.) are accurate, complete, timely, unique, valid, and/or consistent. In some implementations, as described, one or more remediations can be automatically performed by the computer system 102. In some implementations, one or more remediations may be flagged by the computer system 102 and presented to a relevant user (e.g., employee of the online retail environment) to determine whether a change should be made to the item listing.

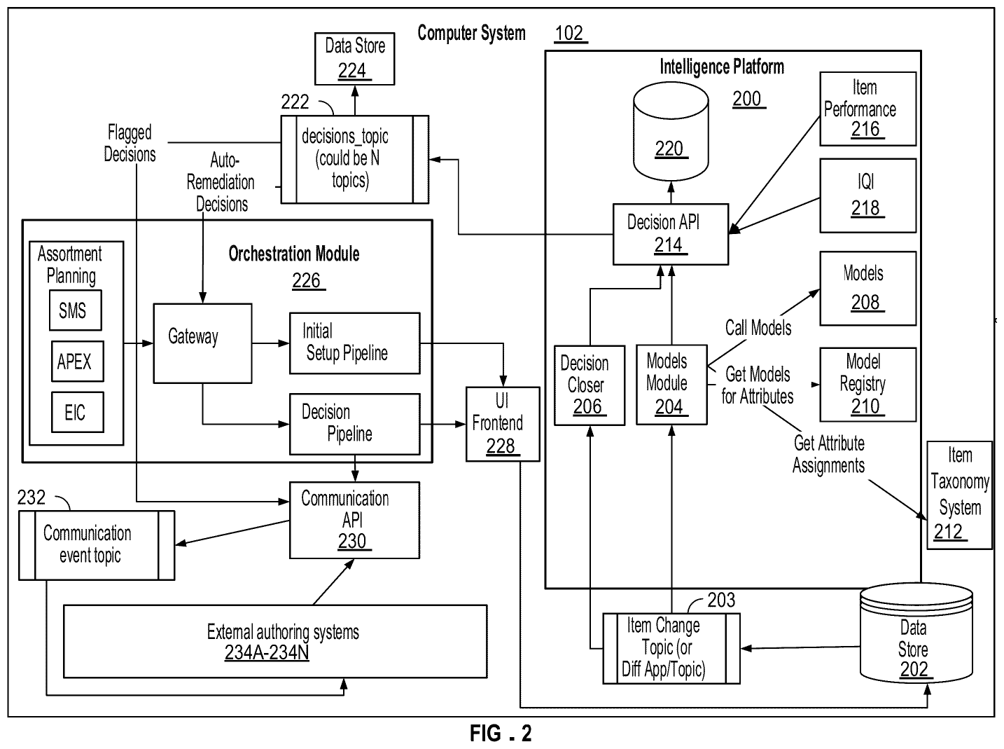

FIG. 2 is a system diagram depicting one or more components that can be used to perform the techniques described herein. Using the components described in FIG. 2, the computer system 102 can determine whether item listing data should be remediated (e.g., modified, fixed, etc.) and whether remediations should/can be performed automatically (by the computer system 102) or flagged and reviewed by a relevant user, such as a quality control analyst or other employee of an online retail environment that sells an item associated with the item listing data.

The computer system 102 can include an intelligence platform 200. The intelligence platform 200 can be a module and/or engine comprising one or more sub-components, sub-modules, and/or sub-engines to perform the techniques described herein. For example, the intelligence platform 200 can be configured to check item listing data for changes and determine one or more remediations that can be performed in response to identifying that the item listing data has changed. The intelligence platform 200 can include a models module 204, a decision closer 206, a decision API 214, and a data store 220. The intelligence platform 200 can also include a model registry 210, models 208, an IQI engine 218, and an item performance engine 216.

The models module 204 can be configured to execute one or more models to determine whether item listing data is accurate and/or should be modified. More particularly, the models module 204 can be an intelligence platform that enables posting of machine learning models and exposing them via one or more APIs (e.g., decision API 214) and relevant data in a scalable way. The models module 204 can therefore make models available and accessible for runtime execution in one or more ecosystems of the online retail environment.

As described herein, the models module 204 can select one or more models to run. For example, the models module 204 can retrieve, from item taxonomy system 212, attributes of the item listing data to analyze. The item taxonomy system 212 can store/contain item data model definitions and information/rules about what selling attributes are assigned to which data types for different item types. The models module 204 can then retrieve, from the model registry 210, a list of models that can be used to analyze one or more of the retrieved attributes. The models module 204 can call the models 208 that were identified from the model registry 210 and apply those models to the item listing data. As described throughout this disclosure, in some implementations, the models module 204 can run all models 208 against the item listing data. The models module 204 can also select a subset of models 208 to run. The models module 204 can select one or more of the models 208 described throughout this disclosure. The models module 204 can also select one or more models that are specific to a particular item type, particular item taxonomy, attributes in the item listing data to be analyzed, attributes per item type, and/or attributes per item taxonomy.

The subset of models 208 can be a set of models that have been trained, verified/validated, enabled, and/or certified for execution by the intelligence platform 200. An enabled model, in some implementations, can be a model that can be run but does not perform actions autonomously—the model can be an ‘operator assist’ model. The enabled model can generate output indicating that something in the item listing data should or can be remediated. The enabled model can also generate predictions of whether information in the item listing data should or can be remediate. Once those predictions are validated, the enabled model can become a certified model. A certified model, on the other hand, is validated and either autonomous or semi-autonomous. Therefore, the certified model can be used for analyzing item listing data of different item categories and generating suggested remediations. Those suggested remediations can then be automatically implemented by the computer system 102 or flagged and reviewed by the relevant user at a user device, such as the user device 104 described in FIG. 1A.

Each of the models 208 can include respective rules, outputs, and decision processes. For example, at least one of the models 208 may include a rule to publish model output if a prediction, generated by the model, to change information in the item listing data has a confidence metric that satisfies a threshold confidence condition. As an example, an item type model can include a rule to publish the model output when there is no confidence that the item listing data should be changed, when the model predicts multiple changes to make to the item listing data, or when the model makes a prediction that does not align with source information for the item listing data (e.g., data from the data store 202 and/or a vendor). Each of the models 208 can also include one or more other rules that are unique to the model.

The decision closer 206 can be a sub-module and/or engine of the intelligence platform 200 that can be configured to intelligently detect whether a decision has been applied. If the decision has been applied (e.g., a potential remediation), the decision closer 206 can report out or otherwise log that decision. The decision closer 206 can also close or otherwise end a decision to check the item listing data and determine one or more potential remediations.

The decision API 214 can be configured to provide communication between the intelligence platform 200 and one or more sub-modules and/or engines. For example, the decision API 214 can provide for communication between the decision closer 206, the models module 214, the IQI engine 218, and/or the item performance engine 216. The IQI engine 218 can be configured to determine and assess various metrics of quality of the item listing data and score those metrics. For example, as described in FIG. 1C, the IQI engine 218 can assess quality of the item listing data based on accuracy, completeness, timeliness, uniqueness, validity, and consistency. The IQI engine 218's assessment of the item listing data can be fed through the decision API 214 to determine, by the intelligence platform 200, whether at least one remediation should be made to the item listing data. Similarly, the item performance engine 216 can be configured to measure performance of the item listing data on the online retail environment. Overall performance can be an indicator of whether the item listing data includes relevant and/or accurate information for consumers searching for and/or wishing to purchase the item associated with the item listing data. Measured performance information can similarly be provided through the decision API 214 to the intelligence platform 200 to determine whether to implement one or more remediations.

The data store 220 can store one or more decisions and/or model outputs that are generated in the intelligence platform 200. For example, model outputs indicating likelihood that a remediation should be made, likelihood that a particular value in the item listing data is incorrect, likelihood that a suggested value is the correct value for the item listing data, suggestions for one or more remediations, and determinations that remediation is not needed can be stored in the data store 220 in association with the item listing data.

During run time execution, item listing data can be received from a data store 202. The data store 202 can contain item listing data for the online retail environment before and/or after that data is published and made available to consumers. Therefore, the data store 202 can contain information that is served to consumers at their respective user devices. The item listing data can also be received from a variety of other sources, as described in reference to FIG. 1A.

The item listing data can be passed through an item change topic 203 in the computer system 102 to determine whether any information in the item listing data has been changed (e.g., since a last time that the item listing data was checked, since some predetermined amount of time has passed, etc.). In some implementations, the computer system 102 can simply listen for changes to the item listing data, which can be recorded by/in the data store 202. If the information in the item listing data has not changed, then the item listing data can be transmitted to the decision closer 206 in the intelligence platform 200. In some implementations, a notification or message can be transmitted from the topic 203 to the decision closer 206 indicating that the item listing data has not been changed. The decision closer 206 can transmit a notification/message to the decision API 214 indicating that the item listing data has not changed and that remediations may not be needed. In some implementations, depending on information received from the IQI engine 218 and/or the item performance engine 216, a decision may still be made in the intelligence engine 220 to remediate the item listing data. As an illustrative example, the item listing data might not have changed but the item listing data can be out of date/not timely, and thus should be looked at by the relevant user.

On the other hand, if the item listing data has been changed in the data store 202, the item listing data and/or a notification/message can be transmitted via the topic 203 to the models module 204. The models module 204 can then perform the operations described above, in which the models module 204 can retrieve and apply one or more machine learning trained models to the item listing data and determine whether remediations should be made. Decisions made by the IQI engine 218 and/or the item performance engine 216 can also be published via the decision API 214 and used in combination with the model modules 204 output to determine one or more remediations by the intelligence platform 200.

Decisions made by the intelligence platform 200 (e.g., no remediation is needed, remediation is needed) can be transmitted from the intelligence platform 200 to other components of the computer system via decision topic 222 (or N quantity of decision topics). The decisions can also be transmitted via topic 222 to data store 224. The data store 224 can store a variety of data for items, such as attributes and other item listing data associated with each item, item type, and/or item category. The data store 224 can store certified datasets, in some implementations.

Decisions to flag item listing data for review by the relevant user can be transmitted via the decision topic 222, through a communication API 230, and to one or more other computing systems, devices, engines, and/or modules. The communication API 230 can be configured to provide communication between these various components (e.g., wired and/or wireless). The communication API 230 can also attribute decisions, such as flagged decisions, to the correct actors. The communication API 230 can generate communication event topics 232, which can be used to transmit notifications and/or messages about the flagged item listing data to the other components. For example, the topics 232 can be transmitted to one or more external authoring systems 234A-N. The external authoring systems 234A-N can send data via the communication API 230 to the computer system 102. Sometimes, the computer system 102 can re-structure the data and/or validate the data. If the computer system 102 identifies one or more issues or potential remediations with the data, the computer system 102 can notify the external authoring systems 234A-N via the communication API 230. The one or more external authoring systems 234A-N receiving such notification(s) can then review and/or remediate the data accordingly.

The topics 232 can also be transmitted to one or more other components not shown in FIG. 2. Feedback, actions, and/or output can be transmitted from any one or more of the external authoring systems 234A-N via the communication API 230 to the computer system 102. The computer system 102 can then perform one or more operations in response to receiving such feedback, actions, and/or output.

As an illustrative example, an item listing can be flagged for having potentially inaccurate package dimensions. A notification (e.g., email) can be transmitted as the topic 232 via the communication API 230 to one of the external authoring systems 234A-N associated with the item listing. The external authoring system, such as a vendor, can review the notification and respond with input indicating correct package dimensions. This input can be received via the communication API 230. The computer system 102 can then update the item listing to include the correct package dimensions, based on the input. One or more other operations are also possible, as described herein. As another example, the compliance message can be published by the communication API 230 to one or more external authoring systems 234A-N associated with the online retail environment. Such compliance message can be checked by the relevant user, such as a quality control analyst, at the external authoring systems 234A-N to determine whether a remediation should be made, whether to implement a suggested remediation, and/or whether to override a suggested remediation. The relevant users at any of the external authoring systems 234A-N can then reject or close out of decisions made by the intelligence platform 200, as described in reference to FIG. 1B.

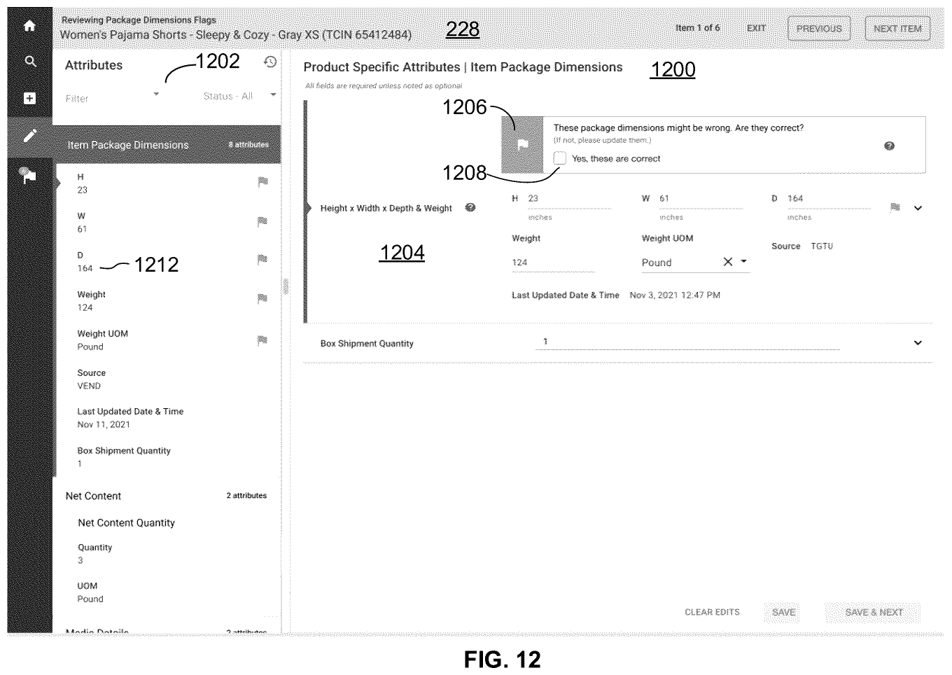

Referring back to the decision topic 222, the decision topic 222 can also indicate that an auto-remediation should be made by the computer system 102. This decision topic 222 can be transmitted to an orchestration module 226. The orchestration model 226 can be configured to take action on one or more decisions that are published via the decision topic 222. For example, the module 226 can determine whether a decision from the topic 222 should be passed to a user interface (UI) frontend 228 and/or the communication API 230. Flagged decisions, for example, may be passed via the orchestration module 226 to the communication API 230, such that the flagged decisions can be communicated to appropriate parties to review the decision and accept, reject, and/or close the decisions. In some implementations, auto-remediation decisions can also be transmitted to the communication API 230 and to relevant parties. Auto-remediation decisions, in some implementations, may be passed via the orchestration module 226 to the UI frontend 228 so that a relevant use can view an auto-remediation that was automatically implemented by the computer system 102. The UI frontend 228 can be presented to relevant users associated with the online retail environment, such as quality control analysts and employees of the retail environment. The UI frontend 228 can present information indicating one or more suggested remediations, flagged decisions for user review, and/or indications of auto-remediation actions that were performed. Refer to FIG. 12 for example output that can be presented at the UI frontend 228.

The relevant user can also provide input at the UI frontend 228, which can be received by the computer system 102 and stored in the data store 202. The input can include one or more changes to the item listing data (e.g., approval of an auto-remediation, approval and/or selection of a suggested remediation, manual remediation, selection and/or performance of an override, etc.), which can then be published to the intelligence platform 200 via the item change topic 203 as described above.

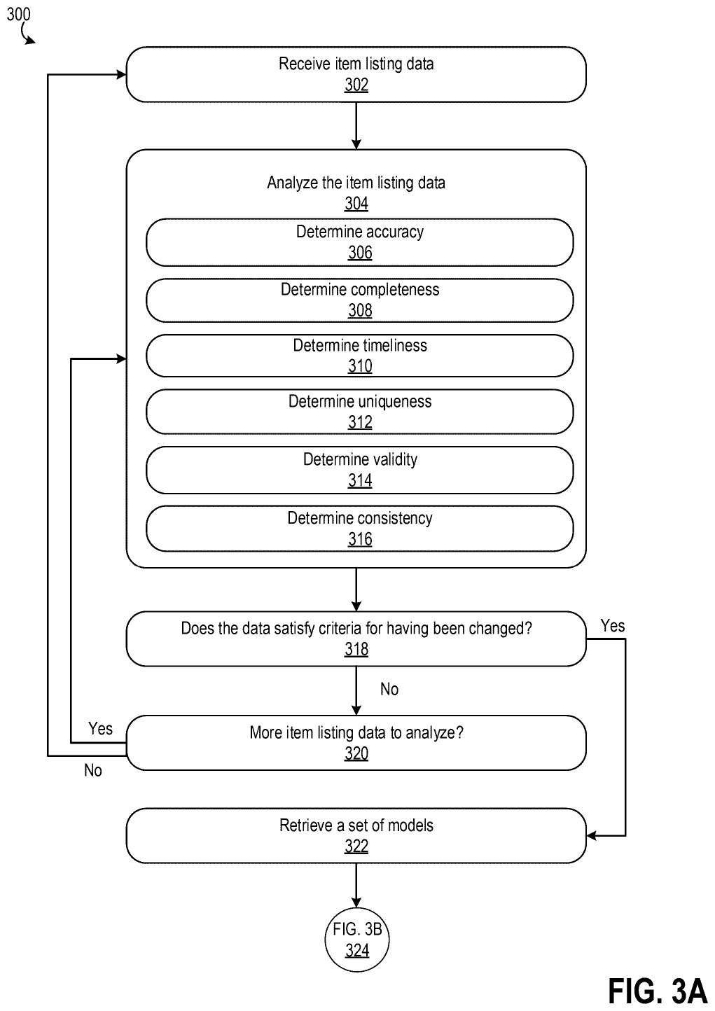

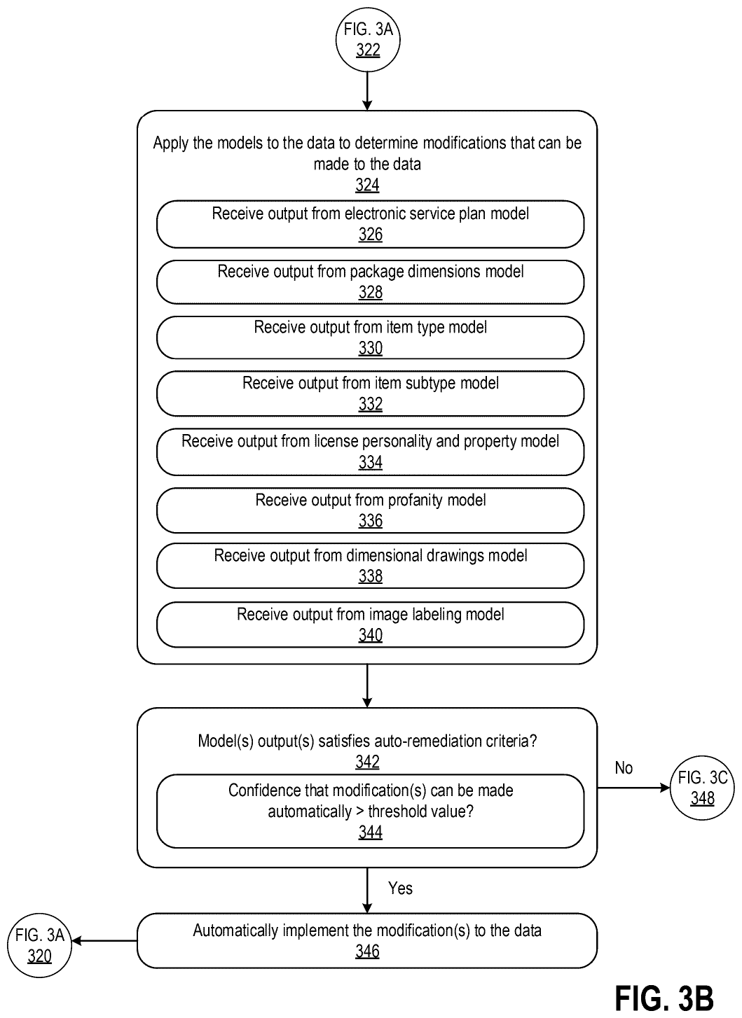

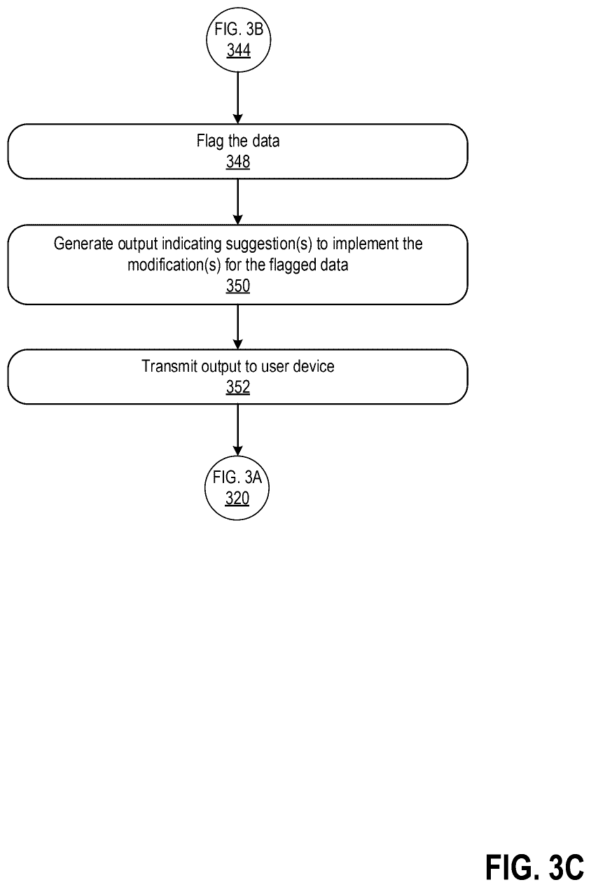

FIGS. 3A-C is a flowchart of a process 300 for remediating item listing data in the online retail environment. The process 300 can be performed by the computer system 102. The process 300 or one or more blocks of the process 300 can also be performed by one or more other computing systems, devices, cloud-based services, and/or networks of devices and/or systems. For illustrative purposes, the process 300 is described from the perspective of a computer system.

Referring to the process 300 in FIGS. 3A-C, the computer system can receive item listing data in block 302. The item listing data can include information about one or more items of one or more item categories that are available in an online retail environment for purchase at devices of consumers, as described in FIGS. 1-2.

In block 304, the computer system can analyze the item listing data. The item listing data can be analyzed to determine whether the item listing data has changed and thus should be checked for potential remediations. Analyzing the listing data can include determining one or more quality characteristics about the item listing data. The quality characteristics can indicate whether the item listing data has changed enough to warrant checking the change to determine if the item listing data should be automatically remediated or flagged and viewed by a relevant user. The quality characteristics can also be used to determine what type of remediations may be warranted and/or whether such remediations can be automatically performed by the computer system or flagged and manually reviewed and addressed by the relevant user.

Analyzing the item listing data can include determining accuracy of the item listing data (block 306), determining completeness (block 308), determining timeliness (block 310), determining uniqueness (block 312), determining validity (block 314), and determining consistency (block 316). Each of the factors determined in blocks 306-316 can indicate (e.g., measure, quantify) different aspects of quality of the item listing and whether improvements (e.g., remediations) can and/or should be made to the item listing to improve its quality. In some implementations, determining the factors in blocks 306-316 can include scoring each of the factors. The scores for the factors can then be combined to determine an average quality score for the item listing data. The average quality score can then be used to determine whether to remediate the item listing data and if so, whether the remediations can be automatically performed or should be flagged for manual human review. In some implementations, the computer system can determine a subset of the factors in blocks 306-316. In some implementations, the computer system may determine only one or less than all the factors in the blocks 306-316. In some implementations, the computer system can determine whether to remediate the item listing data (or whether the item listing data has changed) based on determining less than all the factors in the blocks 306-316. For example, the computer system can determine that timeliness in block 310 is a most important factor and thus, if a timeliness score satisfies a threshold condition (e.g., the item listing data has not been updated in 30 days), the computer system can determine that the item listing data should be checked for remediations, whether those remediations be automatically implemented or manually by the relevant user.

In brief, the computer system can determine accuracy (block 306) based on information in the item listing data such as certification, product title, dimensions, and customer reviews. The more accurate the information, the more accurate the item listing data may be. Accuracy can be determined based on physical in-store audits performed on items to identify item data errors that may appear in the item listings online. As another example, automated audits can be performed of online item listings to identify errors. Consumer data insights (e.g., reviews, feedback, questions, tickets, etc.) can also be used to identify, collect, and score accuracy issues in the item listing data. In some implementations, computer vision techniques can be used to compare data from images of a particular item (or item packaging) with data in the item's online listing and one or more data stores to determine accuracy of the item listing data.

The computer system can determine completeness (block 308) based on identifying missing data such as images, videos, sizing charts, written text, descriptions, one or more specifications, etc. Completeness, such as a completeness score, can therefore be used to measure (e.g., quantify) how much information is filled in or otherwise included in the item listing.

The computer system can determine timeliness (block 310) based on identifying when and how often information in the item listing was or has been updated. The computer system can also determine whether the item listing data has been updated in one or more threshold periods of time. In some implementations, the threshold period of time can be 0-3 months, 3-6 months, 6 months, 6-12 months, 12+ months, etc. The timeliness factor, such as a score, can therefore quantify how recent the item listing data has been updated and/or how often the item listing data is updated. Item listings that contain recently updated information can be assigned higher timeliness scores than item listings that have not been recently updated. Item listings that have not been updated in 12+ months, for example, can be assigned low timeliness scores while item listings that have been updated in the past 0-3 months can be assigned higher timeliness scores.

The computer system can determine uniqueness of the item listing data (block 312) based on identifying whether one or more data entries of the item listing data are duplicated elsewhere, in other systems and/or data stores. The computer system can, for example, receive a title and identifier, such as a barcode, from the item listing data. The computer system can search one or more other systems and/or data stores to see whether the title and/or identifier appear for other item listings. Thus, uniqueness can quantify whether the item listing data has a unique title and/or item/product identifier (e.g., barcode, UPC, etc.). Item listing data that contained a duplicate title and/or identifier can be flagged as not being unique (or having a low uniqueness score).

The computer system can determine validity of the item listing data (block 314) based on identifying whether the listing data includes legal or illegal values, an appropriate taxonomy (e.g., hierarchy), appears in a particular format, and/or follows business rules. Validity can quantify whether a correct and appropriate taxonomy is used for the item listing such that the item can be easily found by consumers in the online retail environment. Validity can also quantify whether values (e.g., item type of a specific MTA value) that are no longer legal values in the computer system are used to describe the item in the item listing.

The computer system can determine consistency (block 316) based on identifying whether information in the item listing data is consistent across data sets. The computer system can check whether values or other data match across data sets. For example, there can be an issue of consistency if the computer system identifies a title in the item listing data to include “&” while a title for the item from a supplier system uses “and.” As another example, warranty information for an item can be provided to the computer system from a source/supplier system, but may not be stored in the retail environment data store. When the item is loaded in the online retail environment in an item listing, the item listing does not pull the warranty information because the warranty information is not stored. As a result, the warranty information is not presented in the item listing even though it should be provided to consumers to facilitate their purchase decisions and experience. This item listing can be considered inconsistent (and assigned a relatively lower consistency score).

Consistency of the item listing data can be measured between (1) source systems, (2) sources to the computer system, (3) retail environment data stores, (4) retail environment data stores to the computer system, (5) source systems to the retail environment data stores, and/or (6) the retail environment data stores to computing devices of relevant users and consumers. Consistency of data can also be measured between one or more other data pipelines and with regards to one or more attributes, including but not limited to merchandise type, item type, package dimensions, brands, etc.

Once the computer system determines one or more of the factors in blocks 306-316, the computer system can determine, based on the determined factors, whether the item listing data satisfies criteria for having been changed (block 318). If the computer system determines that the item listing data satisfies the change criteria, the computer system can proceed to block 322, described below. If the computer system determines that the item listing data does not satisfy the change criteria, the computer system can proceed to block 320.

In some implementations, the process 300 can begin with block 318 instead of blocks 302-316. The computer system can receive, from a data management system, a topic for a change in item listing data. Thus, the data management system can identify when the item listing data is changed and thus publish a notification (e.g., topic) to the computer system indicating that the item listing data has been changed since a list time the item listing data was checked (e.g., the item listing data therefore satisfies criteria for having been changed). The computer system can then proceed with the process 300 at block 320, as described below.

In block 320, the computer system can determine whether there is more item listing data to analyze. If there is more item listing data, the computer system can proceed to block 304 and repeat blocks 304-318 to analyze that item listing data. If the computer system determines that there is no more item listing data to analyze, the computer system can return to block 302 and continue to receive item listing data. In some implementations, the computer system may end the process 300 if there is no more item listing data to analyze.

As mentioned above, if the item listing data satisfies the change criteria in block 318, the computer system can proceed to block 322, in which the computer system can retrieve a set of models to apply to the item listing data. The computer system can proceed to block 322 since the one or more changes to the item listing data have been made and should be checked to determine whether remediations should be made. The computer system can retrieve models used for checking the item listing data for potential remediations and determining whether the remediations can be automatically performed by the computer system or flagged and reviewed by the relevant user. In other words, the computer system can retrieve, from a data store, at least one model that was trained using machine learning techniques to (i) identify changes in other item listing data, (ii) determine at least one suggested remediation to the changes in the other item listing data to generate accurate item listing data, and (iii) determine at least one confidence metric indicating a likelihood that the at least one suggested remediation will result in generating the accurate item listing data. Each of the at least one model, as described further below, was trained to identify a different type of change in the other item listing data.

As described in reference to FIG. 2, the computer system can retrieve all models from a data store or other registry/memory for storing the models. In some implementations, the computer system can retrieve a subset of all the models stored in the data store. For example, the computer system can retrieve models that are associated with one or more of the determined factors from blocks 306-316 (e.g., one or more factors that satisfy threshold conditions). The computer system can also retrieve a subset of models that have been certified or otherwise validated to be executed in the process 300.

In block 324, the computer system can apply the models to the item listing data to determine one or more modifications, or remediations, that can be made to the item listing data. In other words, the computer system can input the item listing data as input to the at least one model that was retrieved. The computer system can determine the modifications from output that is generated by each of the models applied to the item listing data. The computer system can therefore receive output from the at least one model indicating at least one suggestion to remediate the item listing data.

In applying the models, the computer system can receive output from an electronic service plan model (block 326). The computer system may additionally or alternatively receive output from a package dimensions model (block 328). The computer system may additionally or alternatively receive output from an item type model (block 330). The computer system may additionally or alternatively receive output from an item subtype model (block 332). The computer system may additionally or alternatively receive output from a license personality and property model (block 334). The computer system may additionally or alternatively receive output from a profanity model (block 336). The computer system may additionally or alternatively receive output from a dimensional drawings model (block 338). The computer system may additionally or alternatively receive output from an image labeling model (block 340). Although one or more models are described in reference to blocks 326-340, one or more other models may also be retrieved in block 322 and applied in the blocks 324-340. As described herein, one or more additional models can be trained specifically for particular item categories, item types, item attributes, item type attributes, and/or item category attributes. As an illustrative example, a model can be trained to classify comments and survey responses made by users who review and/or purchase items in an online retail environment. By classifying the comments and survey responses, the model can identify whether a particular item listing, a particular item type, and/or a particular item category has a searchability issue. Therefore, one or more of the models can also be trained and executed to detect and/or identify particular types of issues (e.g., searchability, accessibility, etc.) in the item listing data that can and/or should be remediated. In some implementations, the computer system may also leverage open source and/or externally hosted models to perform the disclosed techniques.

In block 326, the computer system can receive output from the electronic service plan model. The electronic service plan model can be trained to determine whether a warranty is available for the item in the item listing data, whether the warranty is applied to the item listing data, and/or whether the warranty can be applied to the item listing data. For example, electronic products and products of one or more other categories (e.g., furniture, home appliances, items of a certain price threshold, etc.) can have applicable warranties. If such warranties are not presented in the item listing data, consumers may not be aware that the products they desire to purchase include warranties. After all, displaying information about the warranties can impact the consumers' decisions to purchase the item in the item listing data. Providing information about the warranty in the item listing data can therefore improve quality of the item listing data and also improve the user's overall shopping experience and decision-making process.

The electronic service plan model can be trained to search one or more data stores and/or systems to determine whether one or more warranties match the item in the item listing data. If a warranty matches the item and has not been applied to the item listing data, the model can generate output indicating that the warranty can be/should be applied to the item listing data. For example, the model can generate a Boolean value, such as True/False and/or Yes/No, indicating whether or not a warranty can and/or should be applied to the item listing data. In some implementations, for example, the model can generate output indicating that the warranty can be automatically applied to the item listing data by the computer system.

In other words, the electronic service plan model could have been trained to determine, based at least in part on the item listing data, whether a warranty applies to the item in the item listing data, determine, based on a determination that the warranty applies, whether the item listing data includes an indication of the warranty, and generate, based on a determination that the item listing data does not include the indication of the warranty, a confidence metric above a threshold value, the confidence metric above the threshold value indicating that the item listing data can be auto-remediated to include the indication of the warranty. In some implementations, the computer system can then auto-remediate the item listing data to include an indication of the warranty based on the confidence metric being above the threshold value (refer to blocks 342-344). In some implementations, the computer system may flag the item listing data based on the confidence metric being below the threshold value or otherwise not satisfying a threshold condition for auto-remediation.

In block 328, the computer system may receive output from the package dimensions model. The package dimensions model can be trained to determine whether package dimensions listed in the data are accurate and/or expected/within threshold ranges for the particular item and/or category of items. Inaccurate package dimensions can mislead the consumers and negatively impact their purchasing decisions and online shopping experience. For example, a table can be listed in an online retail environment with package dimensions that are too large to ship with a particular shipping provider. As a result, shipping costs may be unreasonably high, which can disincline the consumer from purchasing the table. However, if the correct product dimensions were listed, a lower shipping price would be displayed in the online listing for the table, and the consumer may be more comfortable to pay that shipping price. Therefore, accuracy in package dimensions can impact the consumer's purchasing decisions and overall experience in the online shopping experience.

The package dimensions model can be trained to identify a type of the item and/or a category that the item is associated with. The package dimensions model can then identify ranges of package dimensions for items having the identified type and/or category. The model can also be trained to compare the package dimensions listed for the item in the item listing data to the identified ranges of package dimensions to determine whether the item's package dimensions are within some threshold range of the identified range of package dimensions. If the item's package dimensions are not within the threshold range, the model can be trained to generate output indicating a package dimensions outlier for the item listing data. This output can be in the form of a Boolean value, such as True/False (e.g., true for having inaccurate package dimensions and false for having accurate package dimensions) and/or Yes/No (e.g., yes for having inaccurate package dimensions and no for having accurate package dimensions). The output can also be a numeric value, such as a score indicating a likelihood that the item listing data contains a package dimensions outlier. In some implementations, the model can also be trained to determine or otherwise predict product dimensions for the item in the item listing data. When the model predicts product dimensions, the model can also be trained to generate a confidence value indicating a likelihood that the predicted product dimensions are accurate.

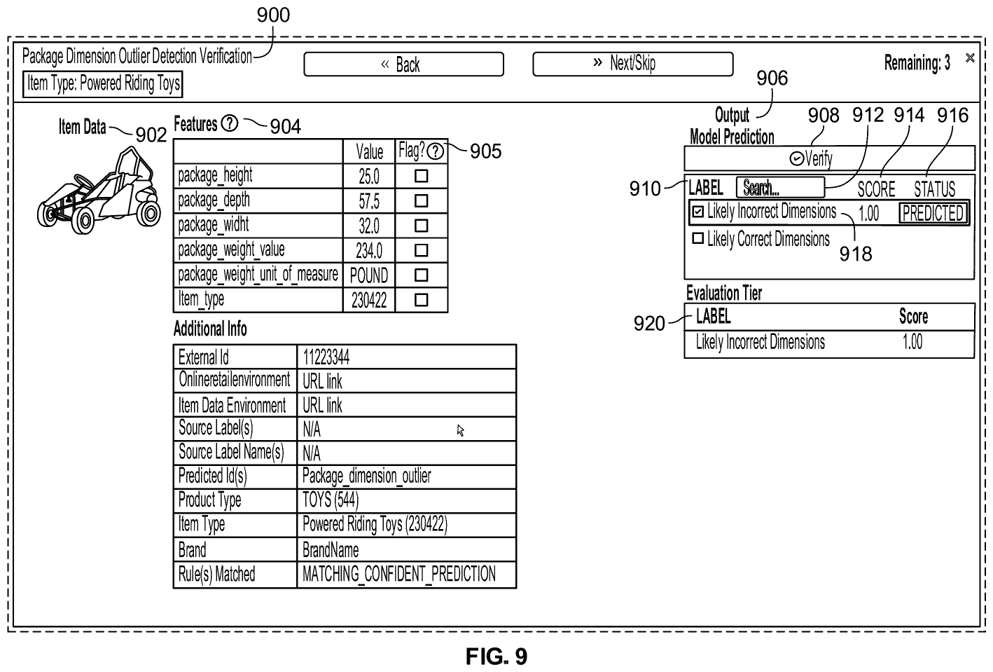

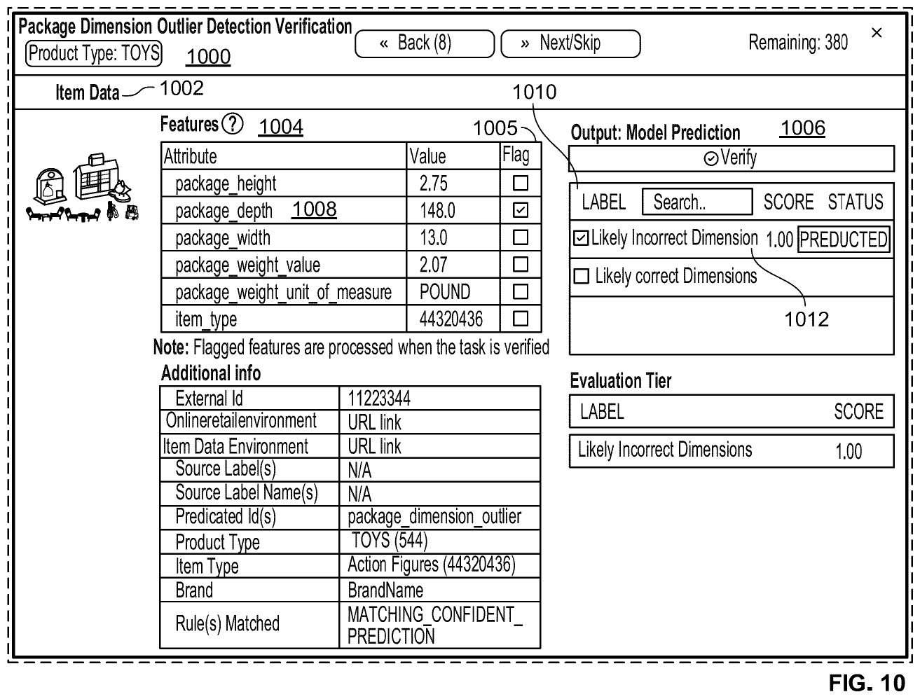

In other words, the package dimensions model was trained (by the computer system or another computing system, as described throughout this disclosure) to determine, based at least in part on the item listing data, whether package dimensions in the item listing data satisfy threshold package dimensions criteria for items of at least one of (i) a same item category and (ii) a same item type, and generate, based on a determination that the item listing data does not satisfy the threshold package dimensions criteria, a confidence metric below a threshold value, the confidence metric below the threshold value indicating that the item listing data should be flagged, by the computing system, for review by the relevant user(s). For example, the model can look at all items in a particular item type and determine an expected or normal package dimensions, such as density, for items of that particular item type. The model can then determine whether the particular item listing data includes a density, or other normal package dimensions, that is normal or expected for the particular item type. The density can be defined as the threshold package dimensions criteria. If the density of the particular item listing data has that density, then the package dimensions can be considered accurate for the particular item listing data. If the particular item listing data does not have that density, the item listing data does not satisfy the threshold package dimensions criteria and the item listing data can be flagged for likely having inaccurate package dimensions. Refer to FIGS. 9 and 10 for additional discussion about the model.

In block 330, the computer system may receive output from the item type model. The item type model can be trained to determine whether the item in the item listing data is associated with a correct category. Item listing data that contains a wrong category or other taxonomy classification can negatively impact consumers' online shopping experience and overall purchasing process. For example, if an item is not listed in its appropriate category, a consumer may not be able to find the item on the online retail environment and thus may not be able to purchase the item.

The model can be trained to check information in the item listing data against information about items in a similar or same category as the item in the item listing data. The model can be trained to identify deviations or differences between the item and the other items in the category to determine whether the item is in the appropriate category. In some implementations, the model can also be trained to flag the data if the item listing data does not include any category for the item. In some implementations, the model can be trained to predict a category that the item listing data should be associated with. For example, the model can compare information in the item listing data to information for items in other item listing data to determine which of the information has the most similarities (e.g., similarities that exceeds a threshold value and/or satisfies some threshold condition). The model can be trained to identify the category of the item listing data having the most similar information as a potential category for the item in the item listing data. The model can also be trained to generate a confidence metric indicating a likelihood that the item listing data contains a wrong category (or no category at all). The confidence metric can be a numeric value on a scale such as 0 to 1 or 1 to 100. One or more other scales can be used. A higher confidence metric can indicate a higher likelihood that the item listing data contains the wrong category whereas a lower confidence metric can indicate a higher likelihood that the item listing data contains the correct category. The model can also be trained to generate output in the form of string and/or Boolean values indicating likelihood that the item listing data contains the wrong category. The model can also be trained to determine a likelihood that the predicted category is the correct category for the item listing data. A higher likelihood can indicate that the model is more confident that the predicted category is the right category versus a lower likelihood. The likelihood can be a numeric value, like the confidence metric mentioned above. In some implementations, the model can also be trained to generate output indicating whether the category should be changed automatically by the computer system and/or whether the category change should be flagged and reviewed by the relevant user. This output can be generated based on one or more of the confidence metric and/or the likelihood value indicating whether the predicted category is the correct category.

In other words, the item type model was trained to predict, based at least in part on the item listing data, at least one item category (e.g., highest level taxonomy) for which to categorize the item associated with the item listing data, determine, for the at least one predicted item category and based at least in part on the item listing data, a confidence metric indicating a likelihood that the at least one predicted item category is a correct item category for the item, generate, based on the confidence metric exceeding a threshold range, instructions that, when executed by the computing system, cause the computing system to auto-remediate the item listing data by adding an indication of the at least one predicted item category to the item listing data, and generate, based on the confidence metric being less than the threshold range, output to be presented at the GUI display of the user device, the output indicating the at least one suggestion to remediate the item listing data. The at least one suggestion can include an option to update the item listing data to include an indication of the at least one predicted item category. Refer to FIG. 7 for additional discussion about the model.

As an illustrative example, an item listing data can have an item type of dance shoes. As a result, the item listing data can be expected to have a first group of attributes associated with dance shoes (e.g., 30 attributes corresponding to color, toe box, heel height, width, etc.). If the item type model generates output that the item listing data should actually have an item type of flats and the item type of flats has a second group of attributes different than the first group of attributes (e.g., the second group has 40 attributes, some of those attributes are the same as attributes in the first group such as color but other attributes are different than those in the first group), then the computing system can flag the item listing data, specifically for the item type element of the item listing data. Although the item listing data could be auto-remediated to change the item type from dance shoes to flats, the computing system may not be able to automatically reconcile all the cascading changes required to be made to the second group of attributes associated with the flats item type. Therefore, flagging the item listing data can be beneficial instead of auto-remediating the item listing data in this example. On the other hand, if the second group of attributes can be automatically reconciled (e.g., all the attributes are the same for both item types) by the computing system when changing the item type to flats, then the computing system can perform an auto-remediation by changing the item type to flats and reconciling the attributes for the item listing data.

In block 332, the computer system may receive output from the item subtype model. The item subtype model can be trained similarly to the item type model. This model can be trained to identify whether the item listing data is correctly associated with one or more sub-categories or other taxonomical structures. In other words, this model can be a more granular version of the item type model. For example, an item type can be flats and slip-on shoes. Item subtypes of this item type can include ballet flats, boat shoes, clogs, etc. Refer to the discussion above regarding block 330 for additional discussion about training the item subtype model and types of output that can be generated by the item subtype model.

In block 334, the computer system may receive output from the license personality and property model. This model can be trained to check associations between the item listing data and licensed products, names, and other licensed items. Associating an item with an incorrect license personality and/or property can lead to misleading advertising and/or marketing, thereby making it more difficult for consumers to find the items they wish to purchase (e.g., items of a different license personality and/or property and/or items of the license personality and/or property) and to make informed purchasing decisions. Moreover, an incorrect association can cause the item listing data to be categorized into an incorrect category and/or the item listing data may appear in searches for the license personality and/or property but not for the category or license personality and/or property that the item listing data is actually associated with. For example, ice cream that is titled as “Rocky Road” may be incorrectly associated with license personality and property of the Rocky movies. This ice cream may appear in searches in the online retail environment for the Rocky movies but not for a category of ice creams. Therefore, consumers may not be able to find the ice cream and thus may not be able to purchase it if that is what they wish to purchase. Additionally, items recommended to the consumer may include those related to the Rocky movies instead of the ice cream. Such recommendations can be misleading to the consumer and therefore may not aid the consumer in having a good experience shopping in the online retail environment.

The model can be trained to determine whether associations with license personality and/or property are appropriate, whether the item in the item listing data should be associated with another license personality and/or property, and/or whether the item in the item listing data is even associated with a license personality and/or property to begin with. The model can also be trained to predict one or more other licensed personalities and/or properties to associate with the item listing data. Similar to the models listed above, the license personality and property model can be trained to determine a confidence metric indicating a likelihood that the item listing data is incorrectly associated with a particular license personality and/or property. The model can also be trained to determine a likelihood metric indicating a likelihood that the predicted association is the correct association to be made for the item listing data.

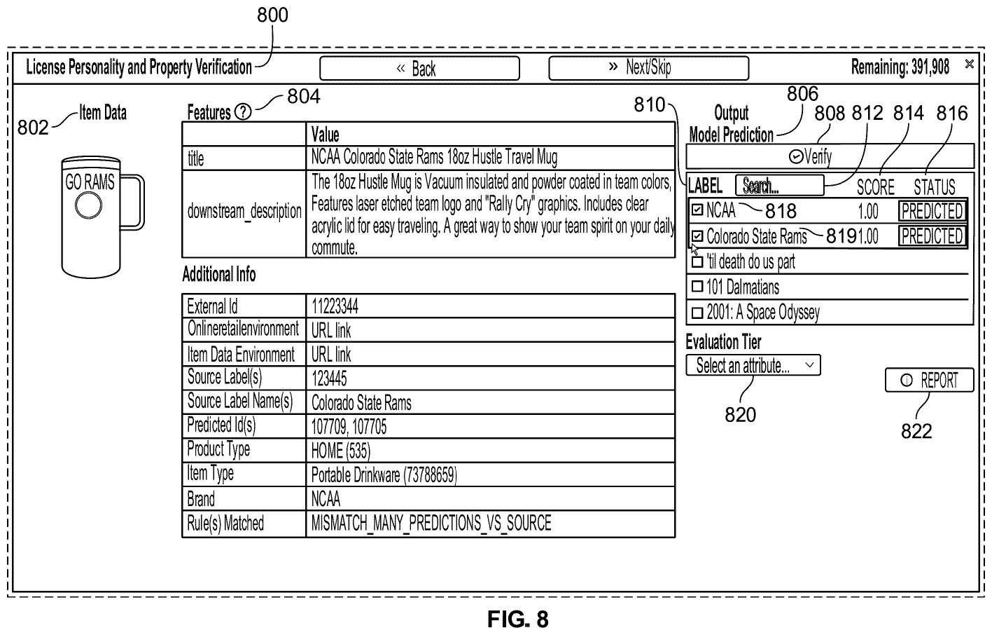

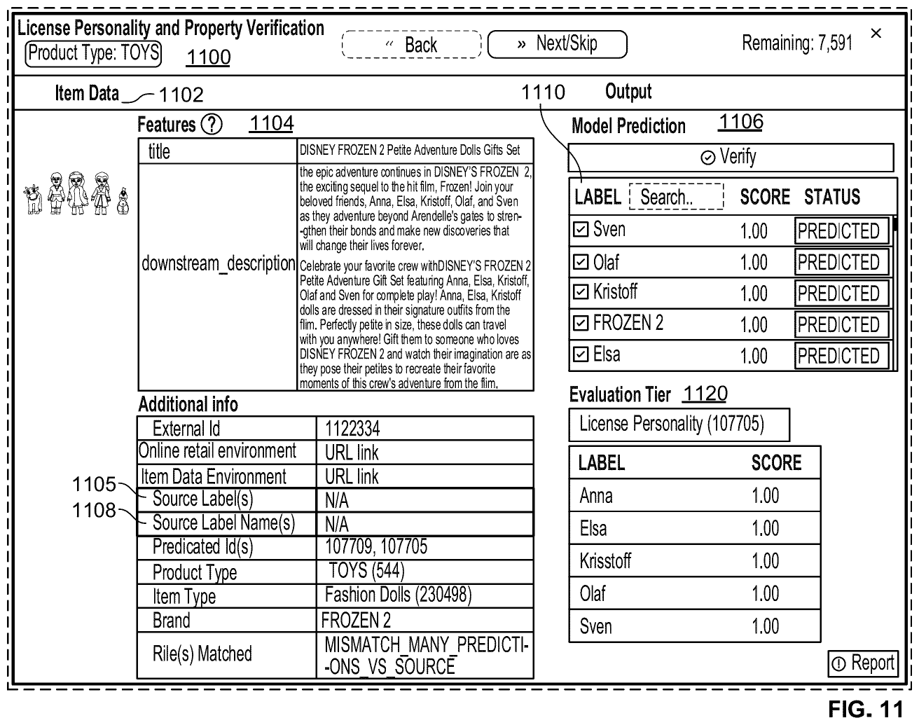

In other words, the license personality and property model was trained to identify, based at least in part on the item listing data, at least one license for which to associate the item in the item listing data, the at least one license including copyrighted or trademarked information. The model can then determine, for the at least one identified license, a confidence metric indicating a likelihood that the at least one identified license is correctly associated with the item in the item listing data. The model can also generate, based on the confidence metric exceeding a threshold range, instructions that, when executed by the computing system, cause the computing system to auto-remediate the item listing data by adding an indication of the at least one license to the item listing data. Moreover, the model can generate, based on the confidence metric being less than the threshold range, output to be presented at the GUI display of the user device. The output can indicate the at least one suggestion to remediate the item listing data. The at least one suggestion can include an option to update the item listing data to include an indication of the at least one identified license. Refer to FIGS. 8 and 11 for additional discussion about the model.

In block 336, the computer system may receive output from the profanity model. The profanity model can be trained to identify profane or other bad words/language/text/images in the item listing data. For examples, some terms or images may be considered profane in some contexts or cultures while being considered acceptable in others. The profanity model can be trained to identify profanity as it relates to a particular context, geographic location, or culture (e.g., corporate or regional culture). Profanities can affect not only quality of the item listing data but also a consumer experience when shopping and searching for items in the online retail environment. A consumer may consider the item listing data offensive/hurtful and/or may be disinclined from purchasing items from the online retail environment when such profanities are used. Therefore, removing profane language from the item listing data (and potentially replacing that language with more appropriate language) can improve the quality of the item listing data, the consumer's overall experience with the online retail environment, and the online retail environment's reputation/business. In some implementations, a listing identified as profane may be prevented from being published or be unpublished entirely, such as item listings for items where the item for sale may be considered profane, indecent, or otherwise inappropriate depending on a given context. For example, references to drugs, alcohol, or sexual content can be identified as profane or inappropriate by the profanity model. For example, the profanity model can identify a logo or word featured on an item of clothing as being associated with drugs which could cause the profanity model to flag the listing as inappropriate or profane. The system can then prevent the item listing from publishing, flag the item listing for removal/unpublishing, or temporarily unpublish the item listing upon further review by a human reviewer.

The model can be trained to identify profanities in the item listing data, generate suggestions for removing the identified profanities (e.g., automatically by the computer system and/or by flagging the item listing data for manual user review), and optionally generate suggestions for replacing the identified profanities with more appropriate language/content. The model, for example, can compare language in the item listing data to language in a list, dictionary, or other data record that are identified as profane or otherwise inappropriate for the online retail environment. If language in the item listing data matches language in the list, the model can generate output indicating that profane language is present in the item listing data. The output, as described above in reference to one or more other models, can be a Boolean value (e.g., Yes/No, True/False, 0/1, etc.) and/or a numeric value (e.g., on a scale of 0 to 100 or any other scale). The output can be similar to the confidence metrics outputted by the other models. The higher the confidence metric, the more likely the language is profane and should be removed in comparison to a lower confidence metric. Optionally, the model can also be trained to suggest language to replace the profane language identified in the item listing data. The model can then generate a likelihood value indicating a likelihood that the suggested language should replace the profane language. The likelihood value and/or the confidence metric can be used by the computer system to determine whether the computer system should automatically remediate the item listing data or flag the data and transmit to the relevant user for manual review.

As an illustrative example, the model can compare language in the item listing data to language in a first list and a second list. The first list, for example, can include language corresponding to known profanities and/or inappropriate language. If any of the language in the item listing data matches language in the first list, the item listing data can be automatically remediated to remove that language. In some implementations, that item listing data can be flagged for immediate review by a relevant user. The second list, for example, can include language that may be considered profane and/or inappropriate to particular user groups, geography, cultures, etc. If language in the item listing data matches language in the second list, the item listing data can be flagged for review by a relevant user. The relevant user can review the language and determine whether, in context of the item type or category associated with the item listing data, the flagged language is in fact profane/inappropriate or normal for the particular item type of category. In some implementations, if the language in the item listing data matches the language in the second list, then the profanity model can also be configured to determine whether that identified language is expected, typical, or normal for the particular item type and/or category associated with the item listing data. For example, the term “trans” can be typical for grocery items (e.g., trans fat) but may not be typical for other types of items, like clothes or books. If the identified language is expected for the particular item type and/or category, the model can determine that the item listing data does not need to be remediated. On the other hand, if the identified language is not expected for the particular item type and/or category, the model can generate output to flag the item listing data for review and/or remediation.

In other words, the profanity model was trained to identify at least one word in the item listing data that satisfies profanity criteria. The model can determine, for the at least one word, a confidence metric indicating a likelihood that the at least one word is profane. Next, the model can generate, based on the confidence metric exceeding a threshold range, instructions that, when executed by the computing system, cause the computing system to auto-remediate the item listing data by removing the at least one word in the item listing data. The model can also generate, based on the confidence metric being less than the threshold range, output to be presented at the GUI display of the user device, the output indicating the at least one suggestion to remediate the item listing data. The at least one suggestion can include an option to update the item listing data to remove the at least one word from the item listing data.

In block 338, the computer system may receive output from the dimensional drawings model. This model can be trained to check images in the item listing data and determine whether those images show correct dimensions for the item and/or whether the dimensions of the item in the images are realistic and sized to scale relative to other objects in the images. An image with inaccurate dimensions can be misleading and thus negatively impact consumers' experience with the online retail environment. For example, a listing for a carpet can include an image of the carpet with a coffee table and loveseat in which the carpet extends a length of the loveseat. The image can include measurements for the carpet as text. A consumer may decide they like this carpet and thus may check if the measurements in the image would fit with their coffee table and loveseat. The consumer can purchase the carpet based off determining that the measurements would work for their living space. However, when the consumer receives the carpet, the carpet may not actually be the same size as the measurements indicated in the image. Instead, the carpet may be half the length and thus not fit with the consumer's furniture as it would appear to fit according to the image in the item listing data. The consumer can therefore have a poor quality shopping experience and may not have trust or interest in shopping at the online retail environment.

The model can be trained to identify images in the item listing data, use OCR techniques to determine whether the images contain text, and if they contain text, determine whether the text includes accurate dimensions associated with the item in the item listing data. The model can be trained to compare the dimensions in the images to known/expected dimensions of similar items or items in a same category. If the dimensions in the images does not satisfy one or more threshold conditions, the model can generate one or more suggestions for new dimensions to include in the images. The model can also be trained to compare sizing of the item in the images to other objects in the images to determine whether the sizing of the item is appropriately scaled. The model can also generate one or more suggestions for how to improve scaling of the item in the images. In some implementations, the model can also be trained to determine whether text in the images complies with one or more accessibility standards. If the text in the images does not comply, the model can suggest one or more changes that can be made to the text in order to ensure compliance. Similar to the models listed above, the dimensional drawings model can be trained to determine a confidence metric indicating a likelihood that text in the images is inaccurate. The model can also be trained to determine a likelihood metric indicating a likelihood that the one or more suggestions are accurate and should be implemented. As described in reference to the other models described above, output generated by the dimensional drawings model can include Boolean values, numeric values, and/or string values.

In other words, the dimensional drawings model was trained to determine, based at least in part on the item listing data, whether an image in the item listing data includes item dimensions, and if so, whether those item dimensions are accurate. The model can also determine, based on a determination that the image includes inaccurate item dimensions, a confidence metric indicating a likelihood that the image includes inaccurate item dimensions. Moreover, the model can generate, based on the confidence metric exceeding a threshold range, output to be presented at the GUI display of the user device, the output indicating the at least one suggestion to remediate the item listing data. The at least one suggestion can include an option to update the item listing data to include accurate item dimensions in the image. Sometimes, the model was also trained to determine, based at least in part on the item listing data, whether text in the image complies with accessibility standards, generate, based on a determination that the text in the image does not comply with the accessibility standards, another confidence metric, and generate, based on the another confidence metric exceeding a threshold range, another output to be presented at the GUI display of the user device, the another output indicating the at least one suggestion to remediate the item listing data. The at least one suggestion can include an option to update the text in the image of the item listing data to comply with the accessibility standards.

In block 340, the computer system may receive output from the image labeling model. This model can be trained to identify and classify types of images representing the item in the item listing data. The model can be trained to identify whether any types of images are missing and/or should be replaced to better represent the item. For example, an item listing for a pair of shoes can include front, side, and back images of the shoes. However, the item listing may not include an image of the bottom of the shoes (e.g., the soles). The consumer may be thinking about whether to purchase the shoes based on whether the shoes have soles with good grip for walking on ice, snow, and slippery surfaces. However, because the item listing does not include an image of the soles, the consumer does not know whether the shoes would work for them, and thus the consumer may make a misinformed decision not to purchase the shoes (even if the shoes in fact have the type of soles the consumer is looking for). Therefore, ensuring the item listing data contains adequate images of the item (and/or packaging of the item) can help the consumer make informed purchasing decisions and improve their overall experience in the online retail environment.

The image labeling model can be trained to classify each of the images in the item listing data. The images, for example, can be compared to a data repository of labeled and annotated images of similar items and/or items of a same or similar category to classify the images in the item listing data. The model can then be trained to determine whether the item listing data includes threshold angles of the item based on analyzing the classified images. In the example of the shoes above, the model can classify the four images as front view, left side, right side, and back view. The model can identify that the item listing data does not contain any image that has been classified as bottom view and/or top view (e.g., these views may be the threshold angles associated with all shoes sold by the online retail environment). Thus, the model can generate output indicating that one or more views/angles of the item are missing in the images. The model can also generate one or more suggestions about what images to include in the item listing data. Similar to the models listed above, the image labeling model can be trained to determine a confidence metric indicating a likelihood that the item listing data does not contain all the appropriate angles/views of the item in the images (e.g., for the particular item type and/or a category of items that the item belongs to). The model can also be trained to determine a likelihood metric indicating a likelihood that the model suggestions are appropriate and/or should be implemented. In some implementations, the model can also generate a confidence metric indicating a likelihood that the model correctly classified the image in the image data. As described above, output from the mode can include a Boolean value, string value, and/or numeric value.

In some implementations, the image labeling model was trained to determine, based at least in part on the item listing data, whether a set of images in the item listing data include threshold viewpoints of an item of the item listing data. The model can determine, based on a determination that the set of images does not include the threshold viewpoints, a confidence metric indicating a likelihood that the set of images is incomplete. The model can also generate, based on the confidence metric exceeding a threshold range, output to be presented at the GUI display of the user device, the output indicating the at least one suggestion to remediate the item listing data. The at least one suggestion can include an option to update the item listing data to include additional images in the set of images that satisfy the threshold viewpoints. The threshold viewpoints can include at least one of a front view of the item, a right side view of the item, a left side view of the item, a top view of the item, a bottom view of the item, and a back view of the item.

Next, in block 342, the computer system can determine whether any of the models outputs of blocks 324-340 satisfy auto-remediation criteria. In other words, the computer system can determine whether at least one suggestion received as output from the at least one applied model satisfies the auto-remediation criteria. The auto-remediation criteria can be defined for and specific to each model. The auto-remediation criteria can require a confidence metric of a first model's suggested modification to satisfy a first threshold value and a confidence metric of a second model's suggested modification to satisfy a second threshold value. The first and second threshold values can be different. For example, the first threshold value can be lower for a model that has a greater impact on determining quality of the item listing data and improving the item listing data's quality than a model having a lesser impact on improving the overall quality. For example, the item type model of block 330 can have a greater impact on quality of the item listing data and consumer experiences than the item subtype model of block 332. Therefore, the item type model can have a lower threshold for the confidence metric to satisfy (in comparison to the item subtype model, which can have a higher threshold for the confidence metric to satisfy) in order to determine that the modification suggested by the model should be automatically implemented by the computer system. In some implementations, the threshold for the confidence metric can be the same regardless of the model that suggested the modification(s). For example, the threshold can be a confidence metric of 100, thereby indicating that the model is the most confident that the item listing data is inaccurate and should be changed.

The auto-remediation criteria can also be based on likelihood that the computer system can automatically implement the modification suggested by the model. For example, the computer system can determine whether a confidence metric (e.g., likelihood that the suggested modification can result in generating accurate item listing data), or other likelihood value described herein, that the modification(s) can be made automatically exceeds a threshold value (e.g., threshold confidence range) (block 344). In some implementations, for example, a likelihood value for one or more models must satisfy a threshold value before the computer system can determine that the modifications suggested by the one or more models should be automatically implemented. In some implementations, the computer system can determine whether it may be too risky to auto-remediate particular item listing data. For example, the computer system may be able to auto-remediate some attributes in the item listing data but not all. As another example, the computer system may not be able to reconcile all cascading attributes in the item listing data should the computer system determine a change should be made to an item type or item category associated with the item listing data. In such examples, if auto-remediation is deemed risky, the computer system can flag the item listing data.

In some implementations, the computer system can determine whether the computer system has authority and/or access rights to implement the change(s) in the item listing data. If the computer system does not have the authority or access rights, then the computer system can flag the item listing data instead of perform auto-remediation. As an example, the computer system may not have authority and/or access rights if the data to be changed in the item listing data is provided by a third party external authoring system. Therefore, the computer system can flag that data in the item listing data and transmit the flag to the third party external authoring system for review and/or remediation. The third party external authoring system can then provide remediated data to the computer system and/or provide an indication that the item listing data does not need to be remediated. As another example, the computer system may not have the authority/access rights to change supply chain data. Therefore, the computer system can flag the supply chain data in the item listing data and transmit that flagged data to a supply chain management system. The supply chain management system can then review and/or remediate the flagged supply chain data. The supply chain management system can provide remediated supply chain data back to the computer system or an indication that the supply chain data does not need to be remediated.

In some implementations, each model can define whether or not auto-remediation is possible based on the model output. For example, certain models may not suggest modifications and therefore modifications cannot be automatically made by the computer system. As another example, models such as the profanity model can generate output indicating whether profanity exists or not in the item listing data. If profanity exists, then the computer system can simply and automatically remove (or remove and replace) the identified profanity. As another example, models such as the license personality and property model can generate output indicating whether the item listing data is associated with the correct license personality and/or personalities. This model can also generate one or more suggested license personality and/or properties for which to associate the item listing data. The model can be uncertain of a definite association to be made, and therefore may require flagging and review by the relevant user rather than automatic remediation by the computer system.

If the computer system determines that the model(s) output(s) does not satisfy the auto-remediation criteria in blocks 342-344, the computer system can proceed to block 348, described below.

If the computer system determines the model(s) output(s) does satisfy the auto-remediation criteria, the computer system can automatically implement the modifications suggested by the model(s) to the item listing data in block 346. For example, the computer system can auto-remediate the item listing data with the suggested modifications based on a determination that the suggested modifications satisfy the auto-remediation criteria.

The computer system can then proceed to block 320, in which the computer system determines whether there is other item listing data to analyze. Therefore, the computer system may not generate output that reports out about the auto-remediations. This can be beneficial to ensure that the relevant users only receive targeted information for their review. Notifications about auto-remediated item listing data can burry other more important notifications about flagged item listing data in a relevant user's inbox. As a result, the relevant user may not get to addressing the flagged item listing data for a while (if at all) and thus the quality of the item listing data cannot be timely improved. However, in some implementations, the relevant user can receive a notification, message, report, or other form of output indicating one or more auto-remediations that were performed by the computer system (e.g., a monthly or weekly report listing all auto-remediations that were performed during that time period).

Referring back to blocks 342-348, if the item listing data cannot be automatically remediated by the computer system, the computer system can flag the item listing data (block 348). The item listing data can be flagged such that it can be brought to the attention of the relevant user for their manual review and/or remediation. In some implementations, the item listing data can be flagged across different datasets and/or computing systems. As a result, a variety of relevant users can be notified or otherwise made aware that the item listing data needs to be manually reviewed and potentially remediated.

The computer system can also generate output indicating one or more suggestions to implement the modification(s) for the flagged data (block 350). For example, the computer system can generate output to be presented at a graphical user interface (GUI) display at a user device of the relevant user. The output can indicate one or more of the suggested modifications as determined by the one or more models. The output can also include confidence metrics associated with each of the modifications, thereby indicating which modifications are more likely to be the best modifications for the particular item listing data. The output can also include one or more selectable options for implementing modifications, rejected modifications, and/or overriding modifications with user-defined modifications. Refer to FIGS. 10 and 12 for additional discussion about the output.

Optionally, in block 350, the computer system can determine which user is relevant and should be receiving the output for the flagged item listing data. This determination can be made based on the type of modifications suggested by the one or more models. This determine can also be made based on criteria specific to each of the one or more models. As shown in reference to FIG. 2, the output can be transmitted to various types of users, including but not limited to vendors, quality control analysts of the online retail environment, other internal workers of the online retail environment, and other third parties who may have the appropriate information to implement the suggested modifications. Determining which entity or entities should receive the output can provide for quicker review and remediation of the flagged item listing data. For example, if the item listing data is missing product images and the suggested modification is to add one or more product images to the item listing data, this suggested modification can be transmitted to a computing device of a vendor, who may already have the product images and thus can more quickly provide the product images to the computer system to update the item listing data than a quality control analyst who does not take or maintain product images for the particular item listing data.

The computer system can transmit the output to a user device (e.g., computing device) of the relevant user(s) in block 352. The output can be transmitted as a notification, message, and/or alert. The output can also be presented at a user interface frontend, such as the UI frontend 228 described in FIG. 2. Refer to FIGS. 7-12.

In some implementations, the process 300, or another process for reviewing and flagging item listing data can be performed as part of a two tiered process for publishing item listings. Such a two tiered process can perform an initial check based on the most important or vital parameters prior to publishing an item listing followed by a secondary check that checks other parameters (and possibly re-checks one or more parameters checked during the initial check) to verify if those parameters are correct or if they need to be adjusted. The listing can then be altered or edited after publishing to correct one or more secondary parameters that are flagged as incorrect or needing attention. Such a two tiered process for checking item listings would allow for item listings to be published in a more timely fashion while ensuring that item listings that have egregious problems can be flagged prior to publishing.

For example, the initial check, sometimes referred to as a primary validation, can include checking parameters identified as the most important. Someone configuring the system can flag which parameters are deemed the most important and should be included in the initial check. For example, a user of the system can use a user interface to select which parameters need to be checked and cleared prior to initial publication of an item listing. Parameters checked during this primary validation can include, for example, checks for profanity, indecency, references to drugs, alcohol, or sexual content, lack of inclusivity, items that deal with controversial topics, other items or listing information that may be considered inappropriate, or items that may face regulatory issues that require verification prior to publishing. If a listing is identified during this initial check as raising one of these concerns, the item listing is temporarily blocked from publishing until a manual review of the listing can be conducted. In some implementations, the computer system can make decisions regarding recommended actions to be taken against the item listing data (or other types of item records and data) in order to remediate the identified issue. In some implementations, item listings identified as potentially being in violation of standards can be classified into two categories depending on the identified issue with the listing. These two categories can include automatically rejecting the item listing, and flagging the item listing for review and approval prior to publishing the item listing.

In such a two tiered implementation, after passing the primary validation, the item listing is published. A secondary validation is then conducted in which other parameters for the listing are checked. These secondary parameters can include item listing parameters that are considered less vital or concerning with respect to initial publication. For example, an item listing in which an item image is blurry or unclear could be flagged as needing remediation without preventing the item listing from publishing. As another example, the system can flag an item listing as having been identified as having missing or possibly incorrect item dimensions. Such issues with a listing can be considered less detrimental and therefore such a listing can be corrected after publication to provide or correct the item dimension information. In some implementations, based on the secondary validation performed after publishing the item listing, the computer system can flag the item listing to indicate that a user, such as an employee of the online retail environment, should review the changed item listing data and determine whether to implement a remediation generated by the computer system. Such flagging decisions can be published to user devices or other user review systems for the user to review and act upon. The computer system can also perform automatic remediations of the item listing data in some implementations. In some implementations, automatic remediations can be a default decision. Then, if the automatic remediation cannot be performed (e.g., a probability that item listing data is erroneous is below a threshold level), the flagging decision can be published as described above.

In some two tiered implementations, if a problem with the item listing is identified during the secondary validation, the item listing can be temporarily unpublished (i.e., the item listing removed) until a manual review by a user can be conducted. In some implementations, the item listing remains published after identification of one or more pieces of item information that should be corrected during the secondary validation. In some implementations, some parameters that are identified as incorrect or requiring remediation during the secondary validation can be flagged as requiring temporary unpublishing of the listing until a manual check can be performed while other potential issues identified during the secondary validation can cause the system to flag the listing while leaving the listing published pending manual review. That is, in some implementations, item listings identified as likely requiring remediation during the secondary validation can be classified into two categories: items that are unpublished until manual review and correction can be performed and items that remain published but are flagged for manual review and correction.

The computer system can then proceed to block 320, as described above. In some implementations, the computer system can end the process 300 after block 352.

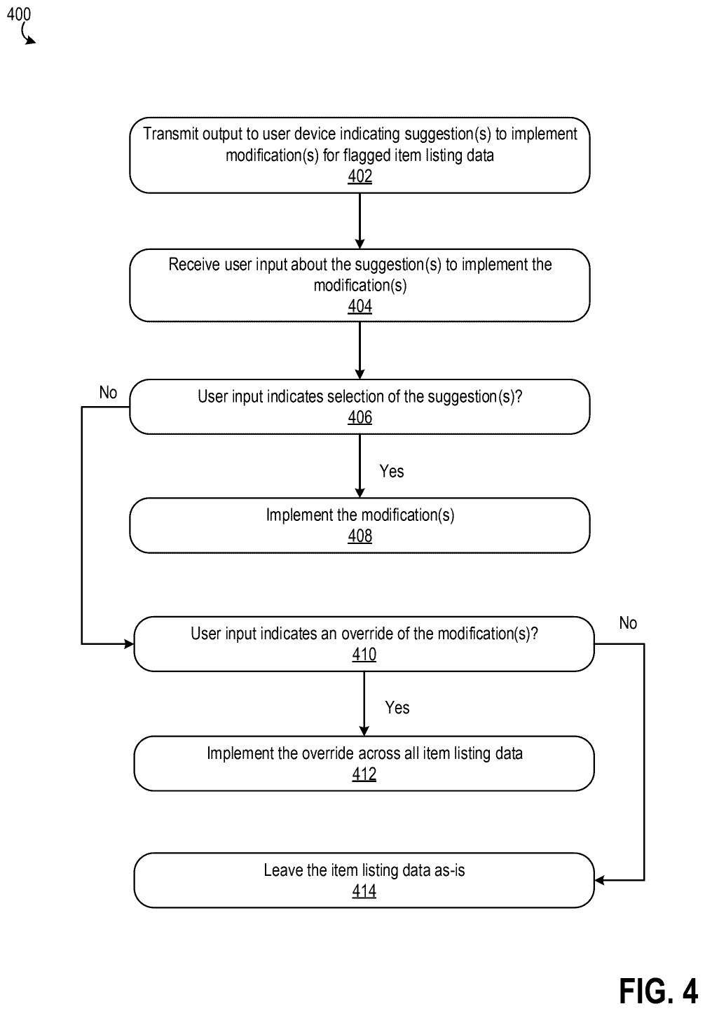

FIG. 4 is a flowchart of a process 400 for manually remediating item listing data in the online retail environment. The process 400 can be performed after block 352 in the process 300 of FIGS. 3A-C. For example, once the computer system transmits output about the suggested modifications to the user device of the relevant users, the process 400 can be performed. The process 400 can be performed by the computer system 102. The process 400 or one or more blocks of the process 400 can also be performed by one or more other computing systems, devices, cloud-based services, and/or networks of devices and/or systems. For illustrative purposes, the process 400 is described from the perspective of a computer system.

Referring to the process 400, the computer system can transmit output to a user device indicating a suggestion(s) to implement a modification(s) for flagged item listing data (block 402). Refer to blocks 348-352 in the process 300 for additional discussion.

In block 404, the computer system can receive user input about the suggestion(s) to implement the modification(s). The user input can be selection of the suggested modification(s). The user input can include deselection of the suggested modification(s). The user input can also include selecting an option to reject a modification that was made by the computer system. For example, as shown in FIG. 10, a package dimensions model can identify inaccurate package dimensions for an item listing and update the package dimensions accordingly. This update can then be transmitted to the user device for the relevant user to confirm this auto-remediation or cancel/reject it. In some implementations, the user input can also be a user-inputted value or values to be added to the item listing data. One or more other user inputs are also possible, as described throughout this disclosure.

The computer system can determine whether the user input indicates selection of the suggestion(s) in block 406. If the user input indicates selection of the suggestion(s), the computer system can implement the modification(s) associated with the selected suggestion(s) in block 408. In other words, the relevant user can review the item listing data and the suggested modification(s) to the item listing data. The relevant user can decide that the suggested modification(s) would be accurate and improve the quality of the item listing data. Hence, the relevant user can confirm or accept the suggested modification(s), which can cause the computer system to apply the suggested modification(s) to the item listing data. In some implementations, the output can include multiple suggested modifications. The relevant user can review the multiple suggested modifications and select one of those to be implemented. The computer system can then receive the input from the relevant user's device indicating selection of the particular modification. The computer system can then implement that particular modification. The process 400 can then end, in some implementations.

If the user input does not indicate selection of the suggestion(s) in block 406, the computer system can determine whether the user input indicates an override of the suggested modification(s) in block 410. An override can indicate that the relevant user does not agree with the suggested modification(s) generated by one or more models. Instead, the relevant user may provide a different value or values for modifying the item listing data. Therefore, the override can be a rejection of the suggested modification(s). In some implementations, the override may also include a different value provided by the relevant user. Other times, the override may simply be a rejection of the suggested modification(s) and thus the relevant user may not desire a remediation to be made.

If the user input indicates an override, the computer system can implement the override across all item listing data (block 412). In some implementations, the computer system may implement the override only for the particular item listing data and/or a subset of all the item listing data, where the subset includes item listing data sharing one or more characteristics with the particular item listing data. For example, the relevant user can select an option to implement the override across all the item listing data, the subset of all the item listing data, and/or just the particular item listing data. In some implementations, the computer system can train one or more of the models described herein with the user override such that the models generate output that aligns with the user override. Therefore, the models may be continuously improved such that they provide suggestions more in line with expectations of the relevant user and the online retail environment.

If the user input does not indicate an override of the modification(s) in block 410, the computer system can leave the item listing data as-is (block 414). In some implementations, the user input can be an inaction (e.g., no user input for a threshold period of time). In some implementations, the user input can be selection of an option to reject the suggested modification(s). In some implementations, the user input can be deselection of the suggested modification(s). The computer system can leave the item listing data as-is because the relevant user may determine that the item listing data is accurate and does not need to be remediated. In some implementations, the computer system can also train/continuously improve one or more of the models based on the user input in block 414. For example, the computer system can improve a model to not generate the type of suggested modification(s) that the relevant user rejected but did not override. As a result, the model may not generate the same type of suggested modification(s) when applied to other item listing data (e.g., item listing data of a same item type and/or category). The process 400 can then end, in some implementations.

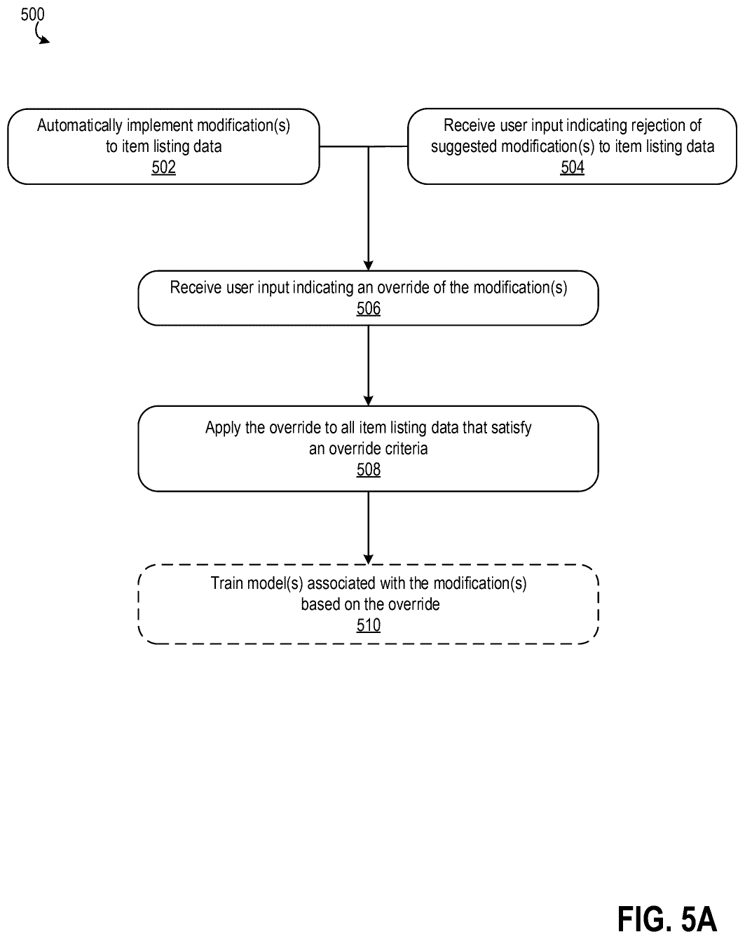

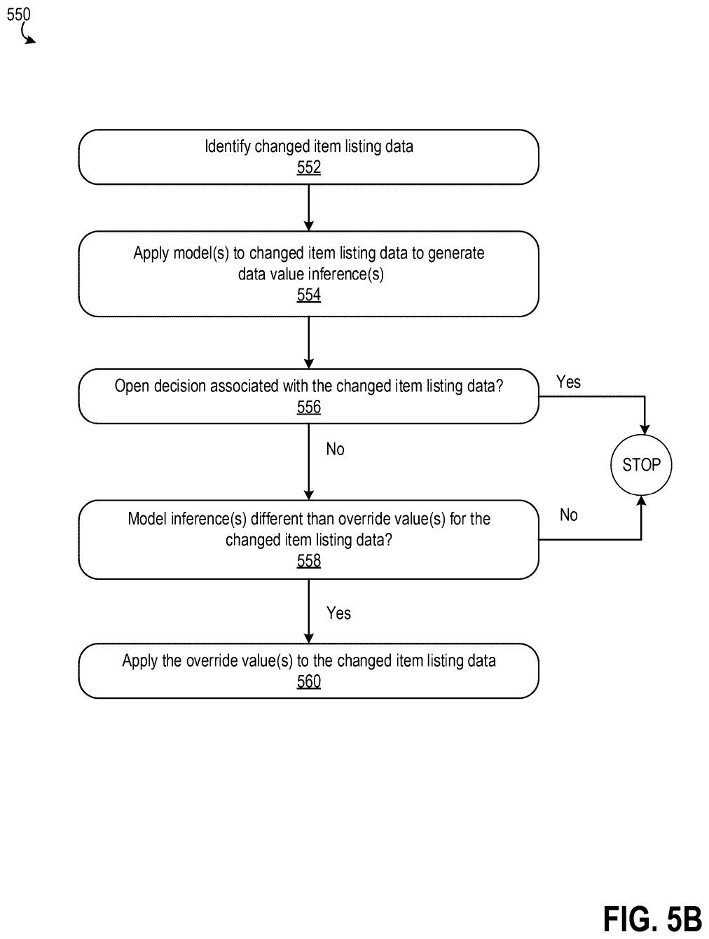

FIG. 5A is a flowchart of a process 500 for overriding a remediation that was made to item listing data in the online retail environment. The process 500 can be performed as part of the process 400 described in FIG. 4. For example, the process 500 can be performed as part of blocks 410-414 in the process 400, in which a relevant user can determine whether to override one or more suggested modifications (e.g., remediations). The process 500 can be performed by the computer system 102. The process 500 or one or more blocks of the process 500 can also be performed by one or more other computing systems, devices, cloud-based services, and/or networks of devices and/or systems. For illustrative purposes, the process 500 is described from the perspective of a computer system.

Referring to the process 500, the computer system can automatically implement a suggested modification(s) to item listing data in block 502. Refer to block 346 in the process 300 of FIGS. 3A-C for additional discussion.

The computer system can also receive user input indicating rejection of the suggested modification(s) to the item listing data in block 504. Refer to block 410 in the process 400 of FIG. 4 for additional discussion. Block 504 can be performed in response to the computer system automatically implementing the suggested modification(s). Block 504 can also be performed in response to the computer system presenting the relevant user with the suggested modification(s) but without automatically implemented it. For example, block 504 can be performed when the item listing data is flagged for manual review and the relevant user is presented with output indicating the suggested modification(s) that can be executed. Therefore, the process 500 can begin with either block 502 or 504. The process 500 can also begin with block 502 followed by block 504. In some implementations, the process 500 can begin with block 504 and not block 502.

After block 502 and/or block 504, the computer system can receive user input indicating an override of the modification(s) (block 506). Refer to block 410 in the process 400 of FIG. 4. For example, the computer system can receive, from a user device of the relevant user, user input indicating (i) a rejection of the suggestion for the flagged item listing data and (ii) a different remediation to be performed for the flagged item listing data. The different remediation may not determined by the computing system. In other words, the relevant user can determine what remediation should be performed and provide that remediation as the different remediation in the user input.

In block 508, the computer system can apply the override to all item listing data that satisfy an override criteria. For example, the override can be applied to all item listing data having a same word or other text in their title and/or description as the item listing data. As another example, the override can be applied to all item listing data having a same vendor as the item listing data. The override criteria can be defined in a variety of ways. In some implementations, for example, the override can be applied to all item listing data that was checked using the same model(s) as the item listing data. In some implementations, the computer system may implement the different remediation as part of the override to update the flagged item listing data. The computer system may not implement the different remediation for other item listing data.

Optionally, the computer system can train one or more models associated with the modification(s) based on the override in block 510. The models can be continuously trained to improve their accuracy in analyzing item listing data and generated suggested modifications for the analyzed item listing data. Therefore, the computer system can train the model that generated the original modification with the user input indicating the override. The computer system can train the model to determine at least another suggested remediation for other item listing data instead of the suggested modification. The at least another suggested remediation can be determined for a subset of the other item listing data that can include at least one of a same type of item as the flagged item listing data and a same item category as the flagged item listing data. In some implementations, the computer system can train the model to determine at least another suggested remediation for other item listing data that includes the different remediation indicated in the user's override. Based on the training, the model can then generate output such as the user override instead of the original modification. In so doing, the model can more accurately analyze the item listing data and generate suggested modifications, which can further reduce the need to flag item listing data and have a user review the data. The item listing data can be remediated quicker, more efficiently, and accurately based on the continuous training and improvements to the models described herein.

FIG. 5B is a flowchart of another process 550 for overriding a remediation inference for item listing data in the online retail environment. The process 550 can be performed to determine whether model inferences differ from actual/expected values for changed item listing data. When the model inferences differ from the actual/expected values, an assumption can be made that a relevant user performed a manual override of the model inferences by providing the actual/expected values to update the changed item listing data. Therefore, whenever the model is applied to subsequent changed item listing data, the process 550 can be performed to determine whether a manual override of the model decision exists and if so, apply that manual override rather than apply the outputted model decision for the subsequent changed item listing data.

The process 550 can be performed as part of the process 400 described in FIG. 4. For example, the process 550 can be performed as part of blocks 410-414 in the process 400, in which a relevant user can determine whether to override one or more suggested modifications (e.g., remediations). The process 550 can be performed by the computer system 102. The process 550 or one or more blocks of the process 550 can also be performed by one or more other computing systems, devices, cloud-based services, and/or networks of devices and/or systems. For illustrative purposes, the process 550 is described from the perspective of a computer system.

Referring to the process 550 in FIG. 5B, the computer system can identify changed item listing data in block 552, as described throughout this disclosure.

The computer system can then apply one or more models to the changed item listing data to generate one or more data value inferences for attributes of the changed item listing data, as described herein (block 554). The models can generate predictions that can then be filtered through policies and/or business rules of the online retail environment. The data value inferences can result from filtering the predictions through the polices and/or business rules. The data value inferences, as described throughout this disclosure, can include values that the models predict as being likely values for the attributes of the changed item listing data. The data value inferences may also include decisions such as auto-remediation or flagging of the changed item listing data.

The computer system can determine whether there is an open decision associated with the changed item listing data in block 556. An open decision can be a decision associated with a data value inference that has not yet been applied to the changed item listing data. For example, an open decision can be when the item listing data is flagged and a relevant user accepts a data value inference for the item listing data but that data value inference has not yet been applied to update the item listing data. The open decision can also be when the data value inference has been rejected by the relevant user. For example, the user may decide that the data value inference is incorrect and may manually close the decision to update the changed item listing data. The open decision can also be when the data value inference has been closed/cancelled by the relevant user. For example, the user may decide that the data value inference has already been applied to the item listing data (e.g., the user applied the data value inference themselves) and thus close the decision to apply the data value inference to update the item listing data.

If there is an open decision, the process 550 can stop. In other words, an override of the inference(s) made by the model(s) may not occur. This is because the user may still perform an action in response to reviewing the data value inference(s), such as accepting the decision, rejecting the decision, or closing/cancelling the decision.

If there is not an open decision, and thus a closed decision exists, the computer system can determine whether the model inference(s) is different than an override value(s) for the attributes of the changed item listing data (block 558). A closed decision can exist, for example, when an auto-remediation is performed to update the changed item listing data with the model inference(s).

If the model inference(s) is the same as the override value(s), the process 550 can stop. This can indicate that the model inference(s) is aligned with expected values or actual values for the corresponding attribute(s) of the changed item listing data.

If the model inference(s) is different than the override value(s) in block 558, the computer system can apply the override value(s) to the changed item listing data in block 560. As a result, the item listing data can be updated to include the override value(s) rather than the model inference(s). The override value(s) can be determined by the relevant user and stored in a data store, as described throughout this disclosure. The override value(s) can indicate expected and/or actual values for particular attributes in the changed item listing data. When the model inference(s) is different than the override value(s), this can indicate that the model is generating inaccurate predictions and therefore inaccurate data value inferences. The override value(s) can therefore be applied to other changed item listing data for which the same model generated the same data value inference(s). Therefore, and as described throughout this disclosure, the override value(s) can also be applied to any other similar or same model inference(s) that are made for other changed item listing data to ensure data accuracy, consistency, and integrity throughout an ecosystem of the online retail environment.

FIG. 6 illustrates an example user interface 600, or GUI 600, presenting models that can be used to determine whether to remediate item listing data. The GUI 600 can be presented at the UI frontend 228 described in FIG. 2. The GUI 600 can be presented to a relevant user, such as an internal worker and/or a quality control analyst for an online retail environment.

The GUI 600 can display a list or table 601 of models that can be used to check the item listing data. The table 601 can include models that are ready to be deployed as well as models that are currently being built and/or trained to perform the techniques described herein. The table 601 can be updated whenever models are updated, trained, verified, and/or built. The table 601 can also be updated at one or more predetermined time intervals (e.g., every 24 hours, twice a week, etc.).

The table 601 can include attributes for a model name 602, deployed 604, enabled 606, certified 608, open verify tasks 610, completed verify tasks 612, percent verified 614, total predictions 616, overrides 618, and last retrained 620. The table 601 can include one or more additional or fewer attributes. In some implementations, the relevant user can also sort and filter the table 601 to include one or more attributes of interest to the user. As described throughout this disclosure, each of the models can be trained to predict an issue with regards to a different attribute in item listing data. Each of the models can therefore have a unique definition of its autonomy. The user can select any of the models listed in the models attribute 602 in order to view additional information about the model and/or output from running the model on item listing data.

The deployed attribute 604 can indicate whether the associated model has been built and ready for use. In other words, the associated model is workable. The enabled attribute 606 can indicate whether the associated model has been tested and used at least in some checks of item listing data. A model that is enabled may still require some human intervention/review in order to ensure that the model is performing as expected. Moreover, an enabled model may work in some use cases (e.g., for some item types) but not in all use cases. The certified attribute 608 can indicate that the associated model has been verified/validated and can be deployed to automatically analyze the item listing data without human intervention/review. In some implementations, certified models are models that are ready for use in any use case in which the models can be deployed. The attributes 604, 606, and 608 can be represented with string and/or Boolean values (e.g., True/False, Yes/No) and/or graphical icons, such as checkmarks and x's. For example, in the table 601, models that are deployed, enabled, and/or certified can include checkmarks for the corresponding attributes 604, 606, and 608. Models that are not deployed, enabled, and/or certified can include x's for the corresponding attributes 604, 606, and 608.

The open verify tasks attribute 610 can include a selectable value indicating how many tasks have been performed with the associated model and require the relevant user to review and verify. By selecting the value for a particular model, the user can be presented another GUI that provides a list of all the open tasks to be verified by the user that involve application of the particular model. The user can verify one or more of the open tasks to determine whether the model is ready to be used during runtime execution. For example, the first model in the table 601 is an electronic service plan model. This model contains 93,176 open tasks to be verified. The open tasks can test various training metrics and accuracy metrics to verify the particular model and decide whether to deploy the particular model for runtime execution. The user can click on or select this attribute 610 in order to be directed to another GUI presenting the 93,176 open tasks. The user can then click into or otherwise select any of those tasks to verify whether the model prediction/output is accurate for corresponding item listing data. In some implementations, one or more of the open tasks can be automatically verified by a computer system described throughout this disclosure. Verifying the open tasks, whether by the user or the computer system, can be a feedback loop for testing and validating a particular model. In some implementations, not all of the open tasks need be verified in order to validate that the particular model is making accurate predictions and output(s).

The completed verify tasks attribute 612 can indicate how many tasks that were performed with the associated model have been checked and verified by the relevant user. In some implementations, the attribute 612 may not be selectable, as shown in the table 601. In some implementations, the attribute 612 can be selectable such that the user can view information about each of the verified tasks.

The percent verified attribute 614 can provide a numeric value, such as a percentage, indicating how many of the total tasks performed with the associated model have been verified. The attribute 614 can provide another way of visualizing and/or understanding how many tasks have been verified relative to how many tasks are still needing to be verified for the associated model.

The total predictions attribute 616 can indicate how many total predictions the associated model has made. The attribute 616 can represent the total predictions over some period of time. For example, the relevant user can filter the table 601 based on defining a period of time, such as a past day, 5 days, week, 2 weeks, month, etc. In some implementations, the total predictions can be represented over an entire period of time that the associated model has been deployed, enabled, and/or certified.

The overrides attribute 618 can indicate how many overrides have been invoked by the relevant user or other users for the associated model. The attribute 618 can be selectable. Selecting the attribute 618 can cause another GUI to be presented to the user that includes information about each of the overrides that were made by the user of the associated model.

The last retrained attribute 620 can indicate when last the associated model was trained and/or updated. As described herein, for example, a model can be trained and/or updated whenever a user override is received at the computer system 102. A model can also be trained/updated at predetermined time intervals, such as once a week, twice a month, once a month, once every 3 months, etc. In some implementations, a model can be trained or otherwise updated whenever the user completes a verification task for the model (e.g., such as accepting or approving the model output or rejecting the model output).

FIG. 7 illustrates an example user interface 700, or GUI 700, presenting potential remediations that can be made based on applying an item type model to item listing data. The relevant user can select the open verify tasks attribute 610 for the item type model from the table 601 in FIG. 6 in order to be presented the GUI 700 shown in FIG. 7. The user can navigate between and amongst different verify tasks that are open for the particular item type model by using the selectable options 701A and 701B (e.g., buttons). For example, the user can select the option 701A to toggle back to previous item listing data that was analyzed using the item type model. The user can select the option 701B to toggle forward to next item listing data that was analyzed using the item type model.

The GUI 700 shown in FIG. 7 presents item listing data 702 for a blanket. The item listing data 702 includes item information 704. The item information 704 can vary per item and/or item listing data. In some implementations, for example, the item information 704 can include an item title, description, URL or other access link, external ID, barcode, UPC, or other unique identifier, source label(s), source label name(s), predicted ID(s), product type, item type, brand, and/or rules that were matched with the item listing data 702. Any one or more of the item information 704 can be provided as input to the item type model and used to determine whether the item type (e.g., the item's category, taxonomy) is accurate. Any one or more of the item information 704 can also be generated by the item type model, such as the predicted ID(s) and rules that were matched.

The item listing data 702 can also be presented with output 706. The output 706 can include one or more model predictions. The output 706 can also include a selectable option 708 to verify the output 706 and/or a selection made amongst predictions presented in the output 706, whether the selection is made by the user or the computer system 102. The output 706 can include a table 710 of labels for all types of categories that the item type model predicted as potentially being associated with the blanket in the item listing data 702. The table 710 can include a search function 712 in which the user can provide input to search the model predictions in the table 710. The table 710 can also include, for each predicted label, a score attribute 714, and a status attribute 716. The score attribute 714 can correspond to the confidence metric and/or likelihood value described herein (e.g., refer to the process 300 in FIGS. 3A-C). In some implementations, the score attribute 714 may not be presented for all predicted labels in the table 710. In some implementations, the score attribute 714 can be presented for one or more predicted labels in the table 710. In the example of FIG. 7, the score attribute 714 is only shown for predicted labels having a highest confidence of being associated with the item listing data 702. Each of the predicted labels presented in the table 710 can also include a selectable option such that the user can select or deselect a label to be associated with the blanket in the item listing data 702. Once the user selects one or more of the labels in the table 710, the user can select the option 708 to confirm their action(s), thereby sending instructions to the computer system 102 to update the category/item type information for the blanket in the item listing data 702 to the selected label(s). This verification task can then be marked as complete in the table 601 described in FIG. 6.

The output 706 can also include an evaluation tier table 720. The table 720 can indicate one or more of the predicted labels likely to be associated with the blanket in the item listing data 702 once one or more business rules are applied to the model predictions in the table 710. For example, the model predicted, as shown in the table 710, that the blanket in the item listing data 702 is of a bed blankets item type. Once this prediction is run through business rules, the computer system described herein can determine that the model prediction is likely accurate and thus the blanket in the item listing data 702 is of the bed blanks item type. Hence, the item type of bed blankets is presented in the evaluation tier table 720.

Moreover, the output 706 can also include a selectable option 722 (e.g., button) that allows the user to report the output from the item type model for the particular item listing data 702. As an illustrative example, if the user selects a different predicted label from the table 710 than the bed blankets label 718, this can be considered a user override. The user can then select the option 722 so that the model, during subsequent use, identifies the user-selected label rather than the label 718 for similar item listing data. As another example, if the user rejects a prediction made by the model, then the user can select the option 722 so that the rejection becomes an override. As a result, the model, during subsequent use, may predict a user-defined override value instead of the prediction that the user had rejected.

In the example GUI 700 in FIG. 7, the item type model analyzed the item information 704 and may have identified “bed blankets” in the title of the item listing data 702. As a result, the model generated output indicating that the blanket in the item listing data 702 should probably be labeled in a category of “Bed Blankets” 718. The model can be highly confident with this prediction, since the text “bed blankets” appears in the item's title. Thus, the model can generate a score of 1.00 on a scale of 0 to 1. The score 714 of 1 can indicate a highest level of confidence that the predicted label is the correct label for the item in the item listing data 702. The status 716 for the category of “Bed Blankets” 718 is “Predicted” and this category has been selected. The user can review the item information 704 can determine whether changing the label/item categorization of this blanket to the category/type 718 is appropriate. If the change is appropriate, the user can select the option 708 to verify the prediction. If the change is not appropriate, the user can select one or more of the other predicted labels presented in the table 710 and then select the option 708 to verify their selection. In some implementations, if the change is not appropriate, the user can simply select the option 722 to report the output 706 of the item type model for this particular item listing data 702.

FIG. 8 illustrates an example user interface 800, or GUI 800, presenting potential remediations that can be made based on applying a license personality and property model to item listing data. The GUI 800 can be presented to the user in a similar manner as described with regards to the GUI 700 in FIG. 7.

Here, the GUI 800 presents item listing data 802 for a travel mug with a RAMS logo on the mug. The model, as described in reference to the process 300, can check associations of the item listing data 802 with licensed personality and/or property to determine whether the correct associations are being made. Thus, item information 804 can be provided as input to the model to perform this analysis. The item information 804 can be the same or similar as the item information 704 described in FIG. 7.

Similar to the model output 706 described in FIG. 7, output 806 can include model predictions, a selectable option 808 to verify the model predictions, a table 810 of predicted associations to make for the mug in the item listing data 802, an evaluation tier table 820, and a selectable option 822 to report the output of the model. The table 810 can further include a search feature 812 and for each predicted association, a score attribute 814 and a status attribute 816.

Here, the model predicted 2 associations that could be made for the mug in the item listing data 802: an “NCAA” association 818 and a “Colorado State RAMS” association 819. Each of the associations 818 and 819 include a score 814 of 1 on a scale of 0 to 1. Each of the associations 818 and 819 also include the status 816 of “Predicted.” Both the associations 818 and 819 have been selected by the computer system 102 since their scores 814 are the highest score that can be assigned (e.g., or otherwise the scores exceeds a threshold value). The user can then select only one of the associations 818 and 819 and/or deselect one or both of the associations 818 and 819. The user can then select the option 808 to verify the selections and cause the computer system 102 to update the item listing data 802 to include labels, brands, or other tagging information identifying “NCAA” and/or “Colorado State RAMS.” In some implementations, one of the associations 818 and 819 (e.g., “NCAA”) can be associated with a brand of the item listing data 802 while the other of the associations 818 and 819 (“Colorado State RAMS”) can be associated with a license personality and property of the item listing data 802. The user may verify, reject, and/or change whether the associations 818 and 819 are properly selected for the brand and for the license personality and property. In some implementations, the associations 818 and 819 can be duplicated across attributes. In other words, “NCAA” and “Colorado State RAMS” can be identified for both brand and license personality and property for the item listing data 802.

FIG. 9 illustrates an example user interface 900, or GUI 900, presenting potential remediations that can be made based on applying a package dimensions model to item listing data. The GUI 900 can be presented to the user similarly as described in reference to the GUIs 700 and 800 in FIGS. 7 and 8, respectively.

The GUI 900 presents item listing data 902 for a go-cart. The item listing data 902 includes item information 904. As shown in FIG. 9, some of the item information 904 can include one or more selectable flags 905. The flags 905 can be selected by the user to indicate that an attribute associated with the selected flag appears to be incorrect.

In FIG. 9, the package dimensions model generates output 906 indicating model predictions. The output 906 includes a selectable option 908 to verify the model predictions, a table 910 with predictions of whether the product dimensions are likely correct for the go-cart in the item listing data 902, and an evaluation tier table 920. The table 910 can also include a search feature 912 and for each prediction, a score 914 and a status 916.

Here, the model predicted that that the item listing data 902 likely has incorrect dimensions, as indicated by row 918 in the table 910. This prediction has a corresponding score of 1 on a scale of 0 to 1, indicating a highest confidence that the dimensions are incorrect. This row 918 has also been selected (either by the computer system 102 because the score 914 exceeds some threshold value and/or by the user when reviewing the model output 906). The model can determine the highest confidence in the dimensions being incorrect by analyzing the package dimensions and expected package dimensions for items of a same item type as the item in the item information 904. For example, other go-carts in the item type of “Powered Riding Toys” may weigh more than 2341b (the weight in the item information 904 may not be within a threshold range of expected weight for items of the same item type), which is shown in the item information 904. The user can then go in and review the weight in the item information 904 and determine whether 2341b is accurate. If 2341b is not accurate for the particular go-cart in the item listing data 902, the user can select the flag 905 for the weight attribute in the item information 904.

FIG. 10 illustrates an example user interface 1000, or GUI 1000, for flagging issues in item listing data that can be auto-remediated or manually remediated. The GUI 1000 is similar to the GUI 900 described in FIG. 9. Both the GUIs 900 and 1000 can be presented to the user when the package dimensions model is applied to item listing data. The GUI 1000 presents item listing data 1002 for a set of toys. The item listing data 1002 includes item information 1004 and model output 1006, as described in reference to FIGS. 7-9. Like the item information 904 in FIG. 9, the item information 1004 includes selectable flags 1005 for one or more package dimension attributes listed in the item information 1004.

Here, the package dimensions model has predicted that the item listing data 1002 includes incorrect dimensions, as indicated by row 1012 in table 1010 in the model output 1006. The computer system 102 has also automatically flagged a particular package dimension 1008 in the item information 1004 that the model is most confident is inaccurate. The package dimension 1008 refers to package depth. The package depth in the item information is recorded as 148 inches. However, the model might have identified that a value of 148 inches is not within a reasonably expected range of values for the particular item type (Action Figures) and/or relative to the other package dimensions for the set of toys in the item listing data 1002 (the package height is only 2.75 inches, package width is 13.0 inches, and weight is only 2.071b). Therefore, the computer system 102 can automatically flag 1005 the package dimension 1008 based on the model output 1006, thereby directing the user's attention to reviewing this particular package dimension and providing a more accurate value for that particular package dimension.

In some implementations, the flags 1005 described in reference to FIGS. 9 and 10 can be assigned when a particular value is an anomaly (as shown in FIG. 10) and should be verified by the user. The model may not be able to predict and suggest a value, and thus the particular package dimension can be flagged for user review, as described in FIG. 10. As another example, a flag can be assigned if an attribute can and should be completed to increase findability. As an illustrative example, a Santa figurine may be missing a value for “Season or event depicted.” This would be a merchandise type attribute, which does not have a current value nor a value proposed by a model. Therefore, this attribute can be flagged and presented to the user to check/verify, as shown and described in FIG. 10. As another example, a flag can be assigned if a barcode or other unique identifier in an item listing data is duplicated with another item listing data. The flag can identify the current value but a model may not be able to predict or propose a new value. Therefore, the flag can be used to direct the user's attention to checking the barcode value. As another example, a flag can be assigned for an item type. The flag can indicate that an item currently has an item type of X but a model predicted that the item type is actually Y. The flag can indicate the current value and may also include a proposed value. Thus, the flag can be used to direct the user to checking the proposed value, determining whether the proposed value is accurate, and then accepting the value.

FIG. 11 illustrates an example user interface 1100, or GUI 1100, for auto-remediating item listing data. The GUI 1100 is similar to the GUIs 900 and 1000 described in FIGS. 9 and 10. The GUI 1100 can be presented to a user when the license personality and property model is applied to the item listing data. In some implementations, as shown in FIG. 11, the computer system 102 can automatically determine and apply source labels to the item listing data based on output from the license personality and property model.

Here, item listing data 1102 is presented for a set of toys associated with the DISNEY FROZEN movie. The item listing data 1102 includes item information 1104 and model output 1106. The model output 1106 further includes a table of 1110 with predicted source labels for the set of toys. Moreover, the model output 1106 includes an evaluation tier table 1120, which can indicate one or more source labels to be automatically applied, updated, and/or changed in the item information 1104 of the item listing data 1102.

The item information 1104 indicates that source label(s) 1105 and source label name(s) 1108 are left blank (“N/A”). Since this information is missing, it can be challenging for a consumer to find the set of toys represented by the item listing data 1102 in an online retail environment, especially if the consumer is searching for toys related to the DISNEY FROZEN movie (e.g., by searching for specific character names from the movie).

The license personality and property model can analyze the item information 1104 to identify potential source labels and therefore license personalities and/or properties that can be associated with the set of toys in the item listing data 1102. For example, the downstream description of the set of toys includes names of characters from the DISNEY FROZEN movie, thereby indicating that the set of toys may be associated with DISNEY and the FROZEN movie. The model can generate the output 1106, indicating in the table 1110 a list of the character names that appear in the downstream description that are associated with the DISNEY FROZEN movie. The model can predict a highest confidence (e.g., score of 1 on a scale of 0 to 1) that each of the character names in the table 1110 should be associated with the set of toys in the item listing data 1102. Thus, the evaluation tier 1120 can be updated and presented in the GUI 1100 to show source labels that can be automatically applied to the item information 1104 in order to associate the item listing data 1102 with the licensed personality and property of DISNEY FROZEN. Since the model prediction(s) have the highest confidence, the computer system 102 can automatically update the item information 1104 by populating the source label(s) 1105 and/or the source label name(s) 1108 with the list of character names in the table 1110. Now, when a consumer searches the online retail environment for any of the character names and/or DISNEY FROZEN, the item listing data 1102 can be returned as a relevant search result. This can improve the consumer's shopping experience and assist them in making purchasing decisions.

FIG. 12 illustrates an example user interface 1200, or GUI 1200, for presenting flagged item listing data to a user, such as a retail environment employee. The GUI 1200, for example, may not be presented to the user if the item listing data is automatically remediated by the computer system 102 described herein. Moreover, the GUI 1200 is merely an illustrative example of information that can be outputted and presented to the user. One or more other GUIs can be generated and provided to the user.

The GUI 1200 can be presented as part of the UI frontend 228 described in reference to FIG. 2. The GUI 1200 can include item information 1202, which can be part of a particular item listing data that has been flagged and is now being presented to the user in the GUI 1200. The GUI 1200 can also include output 1204, which can indicate what aspects of the item information 1202 may need to be changed/remediated, based on applying one or more models to the item information 1202. The GUI 1200 can also include a notification 1206, which can indicate why the item information 1202 was flagged. Optionally, the GUI 1200 can include selectable option 1208. The option 1208 can be selected by the user to close the GUI 1200 and mark the item information 1202 as being fixed (e.g., closing the output 1204).

Here, a depth measurement 1212 in the item information 1202 has been flagged in the GUI 1200. The model might have flagged the depth measurement 1212 because this dimension may not be within an expected depth measurement range for items of a same or similar category. Since the depth measurement 1212 is an outlier, the depth measurement 1212 is flagged and presented for user review in the GUI 1200. Accordingly, the depth measurement 1212 is presented with an alert/warning indicator/graphical element, such as a red circle with an exclamation point therein. The output 1204 therefore shows more information about product dimensions in the item information 1202, and more particularly, with regards to the flagged depth measurement 1212. Moreover, the notification 1206 provides the following message: “Package depth: value was flagged as an anomaly. Please verify.” One or more other messages can also be generated and presented in the notification 1206, as described throughout this disclosure. The user can view the notification 1206 for guidance about what flagged portion of the item information 1202 for which to focus their review. The user can also view and review the output 1204 to determine whether the depth measurement 1212 is in fact accurate or whether the depth measurement 1212 should be changed/remediated. In some implementations, the user can determine that the depth measurement 1212 is accurate. The user can accordingly select the option 1208 in order to identify, to the computer system 102, that the user updated the depth measurement 1212 and thus can close the flagged decision to change the depth measurement 1212.

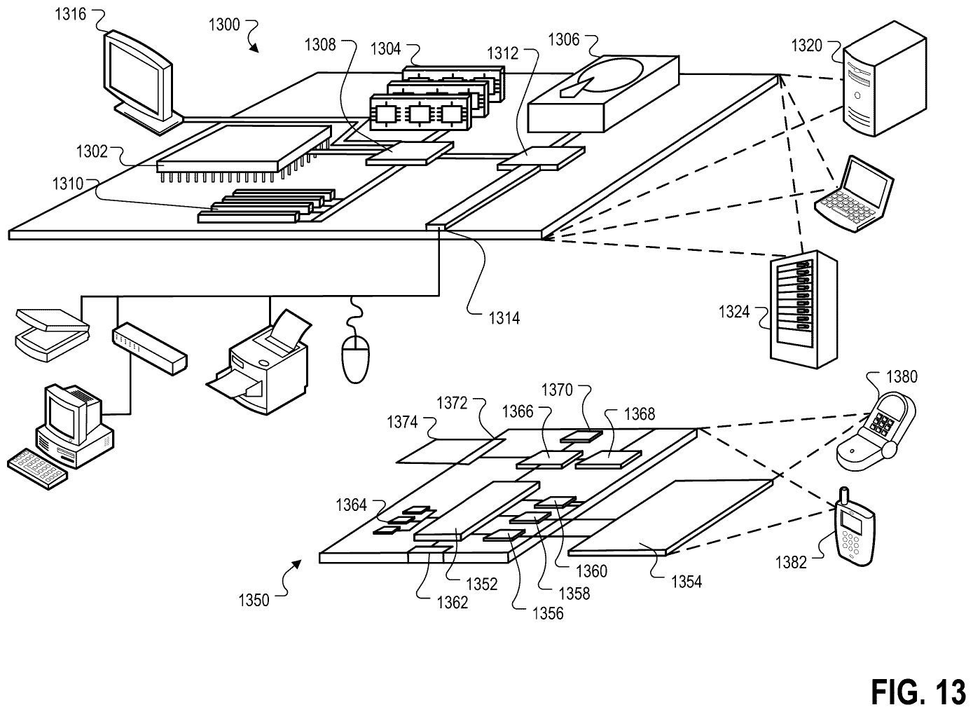

FIG. 13 shows an example of a computing device 1300 and an example of a mobile computing device that can be used to implement the techniques described here. The computing device 1300 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1300 includes a processor 1302, a memory 1304, a storage device 1306, a high-speed interface 1308 connecting to the memory 1304 and multiple high-speed expansion ports 1310, and a low-speed interface 1312 connecting to a low-speed expansion port 1314 and the storage device 1306. Each of the processor 1302, the memory 1304, the storage device 1306, the high-speed interface 1308, the high-speed expansion ports 1310, and the low-speed interface 1312, are interconnected using various busses, and can be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as a display 1316 coupled to the high-speed interface 1308. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1304 stores information within the computing device 1300. In some implementations, the memory 1304 is a volatile memory unit or units. In some implementations, the memory 1304 is a non-volatile memory unit or units. The memory 1304 can also be another form of computer-readable medium, such as a magnetic or optical disk.

The storage device 1306 is capable of providing mass storage for the computing device 1300. In some implementations, the storage device 1306 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1304, the storage device 1306, or memory on the processor 1302.

The high-speed interface 1308 manages bandwidth-intensive operations for the computing device 1300, while the low-speed interface 1312 manages lower bandwidth-intensive operations. Such allocation of functions is exemplary only. In some implementations, the high-speed interface 1308 is coupled to the memory 1304, the display 1316 (e.g., through a graphics processor or accelerator), and to the high-speed expansion ports 1310, which can accept various expansion cards (not shown). In the implementation, the low-speed interface 1312 is coupled to the storage device 1306 and the low-speed expansion port 1314. The low-speed expansion port 1314, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1300 can be implemented in a number of different forms, as shown in the figure. For example, it can be implemented as a standard server 1320, or multiple times in a group of such servers. In addition, it can be implemented in a personal computer such as a laptop computer 1322. It can also be implemented as part of a rack server system 1324. Alternatively, components from the computing device 1300 can be combined with other components in a mobile device (not shown), such as a mobile computing device 1350. Each of such devices can contain one or more of the computing device 1300 and the mobile computing device 1350, and an entire system can be made up of multiple computing devices communicating with each other.

The mobile computing device 1350 includes a processor 1352, a memory 1364, an input/output device such as a display 1354, a communication interface 1366, and a transceiver 1368, among other components. The mobile computing device 1350 can also be provided with a storage device, such as a micro-drive or other device, to provide additional storage. Each of the processor 1352, the memory 1364, the display 1354, the communication interface 1366, and the transceiver 1368, are interconnected using various buses, and several of the components can be mounted on a common motherboard or in other manners as appropriate.

The processor 1352 can execute instructions within the mobile computing device 1350, including instructions stored in the memory 1364. The processor 1352 can be implemented as a chipset of chips that include separate and multiple analog and digital processors. The processor 1352 can provide, for example, for coordination of the other components of the mobile computing device 1350, such as control of user interfaces, applications run by the mobile computing device 1350, and wireless communication by the mobile computing device 1350.

The processor 1352 can communicate with a user through a control interface 1358 and a display interface 1356 coupled to the display 1354. The display 1354 can be, for example, a TFT (Thin-Film-Transistor Liquid Crystal Display) display or an OLED (Organic Light Emitting Diode) display, or other appropriate display technology. The display interface 1356 can comprise appropriate circuitry for driving the display 1354 to present graphical and other information to a user. The control interface 1358 can receive commands from a user and convert them for submission to the processor 1352. In addition, an external interface 1362 can provide communication with the processor 1352, so as to enable near area communication of the mobile computing device 1350 with other devices. The external interface 1362 can provide, for example, for wired communication in some implementations, or for wireless communication in other implementations, and multiple interfaces can also be used.

The memory 1364 stores information within the mobile computing device 1350. The memory 1364 can be implemented as one or more of a computer-readable medium or media, a volatile memory unit or units, or a non-volatile memory unit or units. An expansion memory 1374 can also be provided and connected to the mobile computing device 1350 through an expansion interface 1372, which can include, for example, a SIMM (Single In Line Memory Module) card interface. The expansion memory 1374 can provide extra storage space for the mobile computing device 1350, or can also store applications or other information for the mobile computing device 1350. Specifically, the expansion memory 1374 can include instructions to carry out or supplement the processes described above, and can include secure information also. Thus, for example, the expansion memory 1374 can be provide as a security module for the mobile computing device 1350, and can be programmed with instructions that permit secure use of the mobile computing device 1350. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1364, the expansion memory 1374, or memory on the processor 1352. In some implementations, the computer program product can be received in a propagated signal, for example, over the transceiver 1368 or the external interface 1362.

The mobile computing device 1350 can communicate wirelessly through the communication interface 1366, which can include digital signal processing circuitry where necessary. The communication interface 1366 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1368 using a radio-frequency. In addition, short-range communication can occur, such as using a Bluetooth, WiFi, or other such transceiver (not shown). In addition, a GPS (Global Positioning System) receiver module 1370 can provide additional navigation- and location-related wireless data to the mobile computing device 1350, which can be used as appropriate by applications running on the mobile computing device 1350.

The mobile computing device 1350 can also communicate audibly using an audio codec 1360, which can receive spoken information from a user and convert it to usable digital information. The audio codec 1360 can likewise generate audible sound for a user, such as through a speaker, e.g., in a handset of the mobile computing device 1350. Such sound can include sound from voice telephone calls, can include recorded sound (e.g., voice messages, music files, etc.) and can also include sound generated by applications operating on the mobile computing device 1350.

The mobile computing device 1350 can be implemented in a number of different forms, as shown in the figure. For example, it can be implemented as a cellular telephone 1380. It can also be implemented as part of a smart-phone 1382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for implementing remediations to item listing data in an online retail environment, the method comprising:
receiving, by a computing system from a data management system, a topic for a change in item listing data;
retrieving, by the computing system from a data store, at least one model that was trained using machine learning techniques to (i) identify changes in other item listing data, (ii) determine at least one suggested remediation to the changes in the other item listing data to generate accurate item listing data, and (iii) determine at least one confidence metric indicating a likelihood that the at least one suggested remediation will result in generating the accurate item listing data;
inputting, by the computing system, the item listing data associated with the topic as input to the at least one model;
receiving, by the computing system, output from the at least one model indicating at least one suggestion to remediate the item listing data;
determining, by the computing system, that the at least one suggestion satisfies auto-remediation criteria; and
auto-remediating, by the computing system and based on a determination that the at least one suggestion satisfies the auto-remediation criteria, the item listing data with the at least one suggestion.

2. The method of claim 1, wherein the at least one model is at least one of an electronic service plan model, a package dimensions model, an item type model, an item subtype model, a license personality and property model, a profanity model, a dimensional drawings model, and an image labeling model.

3. The method of claim 1, wherein determining, by the computing system, that the at least one suggestion satisfies auto-remediation criteria comprises determining that a confidence metric generated by the at least one model and received as output from the at least one model exceeds a threshold confidence range, wherein the confidence metric indicates the likelihood that the at least one suggestion results in generating accurate item listing data.

4. The method of claim 1, further comprising:
receiving, by the computing system from the data management system, a topic for a change in second item listing data;
inputting, by the computing system, the second item listing data as input to the at least one model;
receiving, by the computing system, output from the at least one model indicating a second suggested remediation for the second item listing data;
determining, by the computing system, that the second suggested remediation does not satisfy the auto-remediation criteria;
flagging, by the computing system and based on the determination that the second suggested remediation does not satisfy the auto-remediation criteria, the second item listing data as flagged item listing data;
generating, by the computing system, output to be presented in a graphical user interface (GUI) display at a user device indicating the second suggested remediation for the flagged item listing data; and
transmitting, by the computing system to the user device, the generated output.

5. The method of claim 4, further comprising:
receiving, by the computing system from the user device, user input indicating (i) a rejection of the second suggested remediation and (ii) identification of a user-defined remediation for the flagged item listing data;
implementing, by the computing system, the user-defined remediation to update the flagged item listing data; and
training, by the computing system, the at least one model to identify the user-defined remediation as a remediation for the other item listing data that does not satisfy the auto-remediation criteria.

6. The method of claim 5, further comprising training, by the computing system, the at least one model to identify the user-defined remediation for the other item listing data instead of the second suggested remediation.

7. The method of claim 5, wherein the model is trained to identify the user-defined remediation for a subset of the other item listing data, wherein the subset of the other item listing data has at least one of (i) a same item type as the flagged item listing data and (ii) a same item category as the flagged item listing data.

8. The method of claim 1, wherein the at least one model was trained to identify, in the other item listing data, changes in at least one of item: accuracy, completeness, timeliness, uniqueness, validity, and consistency.

9. The method of claim 8, wherein:
a change in the item accuracy comprises at least one of an inaccurate item type and inaccurate package dimensions,
a change in the item completeness comprises a missing merchant type attribute that is required for the other item listing data,
a change in the item timeliness comprises a threshold amount of time that passed since the other item listing data was updated,
a change in the item uniqueness comprises an item identifier or an item title that is identical to another item identifier or another item title,
a change in the item validity comprises at least one of an invalid brand and an invalid item taxonomy, and
a change in the item consistency comprises an inconsistency of at least one of brand and item taxonomy for the other item listing data across data systems associated with the online retail environment.

10. The method of claim 1, wherein the at least one model is an electronic service plan model that was trained to:
determine, based at least in part on the item listing data, whether a warranty applies to an item in the item listing data;
determine, based on a determination that the warranty applies, whether the item listing data includes an indication of the warranty; and
generate, based on a determination that the item listing data does not include the indication of the warranty, a confidence metric above a threshold value, the confidence metric above the threshold value indicating that the item listing data can be auto-remediated to include the indication of the warranty.

11. The method of claim 10, further comprising auto-remediating, by the computing system and based on the confidence metric being above the threshold value, the item listing data to include an indication of the warranty.

12. The method of claim 1, wherein the at least one model is a package dimensions model that was trained to:
determine, based at least in part on the item listing data, whether package dimensions in the item listing data satisfy threshold package dimensions criteria for items of at least one of (i) a same item category and (ii) a same item type; and
generate, based on a determination that the item listing data does not satisfy the threshold package dimensions criteria, a confidence metric below a threshold value, the confidence metric below the threshold value indicating that the item listing data should be flagged, by the computing system, for review by a user of the user device.

13. The method of claim 1, wherein the at least one model is an item type model that was trained to:
predict, based at least in part on the item listing data, at least one item category for which to categorize an item associated with the item listing data;
determine, for the at least one predicted item category and based at least in part on the item listing data, a confidence metric indicating a likelihood that the at least one predicted item category is a correct item category for the item;
generate, based on the confidence metric exceeding a threshold range, instructions that, when executed by the computing system, cause the computing system to auto-remediate the item listing data by adding an indication of the at least one predicted item category to the item listing data; and
generate, based on the confidence metric being less than the threshold range, output to be presented at the GUI display of the user device, the output indicating the at least one suggestion to remediate the item listing data, wherein the at least one suggestion includes an option to update the item listing data to include an indication of the at least one predicted item category.

14. The method of claim 1, wherein the at least one model is a license personality and property model that was trained to:
identify, based at least in part on the item listing data, at least one license for which to associate an item in the item listing data, the at least one license including copyrighted or trademarked information;
determine, for the at least one identified license, a confidence metric indicating a likelihood that the at least one identified license is correctly associated with the item in the item listing data;
generate, based on the confidence metric exceeding a threshold range, instructions that, when executed by the computing system, cause the computing system to auto-remediate the item listing data by adding an indication of the at least one license to the item listing data; and
generate, based on the confidence metric being less than the threshold range, output to be presented at the GUI display of the user device, the output indicating the at least one suggestion to remediate the item listing data, wherein the at least one suggestion includes an option to update the item listing data to include an indication of the at least one identified license.

15. The method of claim 1, wherein the at least one model is a profanity model that was trained to:
identify at least one word in the item listing data that satisfies profanity criteria;
determine, for the at least one word, a confidence metric indicating a likelihood that the at least one word is profane;
generate, based on the confidence metric exceeding a threshold range, instructions that, when executed by the computing system, cause the computing system to auto-remediate the item listing data by removing the at least one word in the item listing data; and
generate, based on the confidence metric being less than the threshold range, output to be presented at the GUI display of the user device, the output indicating the at least one suggestion to remediate the item listing data, wherein the at least one suggestion includes an option to update the item listing data to remove the at least one word from the item listing data.

16. The method of claim 1, wherein the at least one model is a dimensional drawings model that was trained to:
determine, based at least in part on the item listing data, whether an image in the item listing data includes item dimensions;
determine, based on a determination that the image includes item dimensions, whether the item dimensions are accurate for items of a same type as the item listing data;
determine, based on a determination that the image includes inaccurate item dimensions, a confidence metric indicating a likelihood that the image includes inaccurate item dimensions; and
generate, based on the confidence metric exceeding a threshold range, output to be presented at the GUI display of the user device, the output indicating the at least one suggestion to remediate the item listing data, wherein the at least one suggestion includes an option to update the item listing data to include accurate item dimensions in the image.

17. The method of claim 16, wherein the dimensional drawings model was further trained to:
determine, based at least in part on the item listing data, whether text in the image complies with accessibility standards;
generate, based on a determination that the text in the image does not comply with the accessibility standards, another confidence metric; and
generate, based on the another confidence metric exceeding a threshold range, another output to be presented at the GUI display of the user device, the another output indicating the at least one suggestion to remediate the item listing data, wherein the at least one suggestion includes an option to update the text in the image of the item listing data to comply with the accessibility standards.

18. The method of claim 1, wherein the at least one model is an image labeling model that was trained to:
determine, based at least in part on the item listing data, whether a set of images in the item listing data include threshold viewpoints of an item of the item listing data;
determine, based on a determination that the set of images does not include the threshold viewpoints, a confidence metric indicating a likelihood that the set of images is incomplete; and
generate, based on the confidence metric exceeding a threshold range, output to be presented at the GUI display of the user device, the output indicating the at least one suggestion to remediate the item listing data, wherein the at least one suggestion includes an option to update the item listing data to include additional images in the set of images that satisfy the threshold viewpoints.

19. The method of claim 18, wherein the threshold viewpoints include at least one of a front view of the item, a right side view of the item, a left side view of the item, a top view of the item, a bottom view of the item, and a back view of the item.

20. A computing system for determining remediations to item listing data in an online retail environment, the computing system comprising:
one or more processors; and
one or more computer-readable devices including instructions that, when executed by the one or more processors, cause the computing system to perform operations that include:
receiving, from a data management system, a topic for a change in item listing data;
retrieving, from a data store, at least one model that was trained using machine learning techniques to (i) identify changes in other item listing data, (ii) determine at least one suggested remediation to the changes in the other item listing data to generate accurate item listing data, and (iii) determine at least one confidence metric indicating a likelihood that the at least one suggested remediation will result in generating the accurate item listing data;
inputting the item listing data associated with the topic as input to the at least one model;
receiving output from the at least one model indicating at least one suggestion to remediate the item listing data;
determining that the at least one suggestion satisfies auto-remediation criteria; and
auto-remediating, based on a determination that the at least one suggestion satisfies the auto-remediation criteria, the item listing data with the at least one suggestion.
